(19) United States
(12) Patent Application Publication
(10) Pub. No.: US 2007/0197362 A1
(43) Pub. Date: Aug. 23, 2007

(54) Conductive elastic roller and image forming apparatus comprising the same

(75) Inventors: Junji Sakata, Tokyo (JP); Shuyou Akama, Saitama-shi (JP); Hiroyuki Kanesugi, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: BRIDGESTONE CORPORATION, Tokyo (JP)

(21) Appl. No.: 11/700,824

(22) Filed: Feb. 1, 2007

(30) Foreign Application Priority Data
Feb. 2, 2006 (JP) 2006-025792
Feb. 2, 2006 (JP) 2006-025929
Feb. 2, 2006 (JP) 2006-026072
Jan. 30, 2007 (JP) 2007-018752
Mar. 14, 2006 (JP) 2006-068975
Feb. 2, 2006 (JP) 2006-026080

(51) Int. Cl. F16C 13/00

(52) U.S. Cl. 492/49; 492/53

(57) ABSTRACT

This invention provides a conductive elastic roller (1) comprising a shaft member (2), one or more elastic layers (3) disposed on an outside of the shaft member (2) in a radial direction and optionally one or more coating layers (4) disposed on an outside of the elastic layer (3) in a radial direction, characterized in that at least one of the elastic layers (3) is composed of an ultraviolet-curing type resin formed by curing the specified raw material for the elastic layer through ultraviolet irradiation.

### TECHNICAL FIELD

This invention relates to a conductive elastic roller and an image forming apparatus comprising such a conductive elastic roller, and more particularly to a conductive elastic roller suitable as a developing roller, a charging roller or the like.

### BACKGROUND ART

In general, a roll-shaped conductive elastic member, i.e. a conductive elastic roller is frequently used as a developing roller, a charging roller, a toner feed roller, a transfer roller, a paper feed roller, a cleaning roller, a pressure roller for fixing or the like in an image forming apparatus of an electro-photographic system such as a copying machine, a facsimile, a laser beam printer (LBP) or the like. The conductive elastic roller comprises a shaft member usually journaled at both ends in a lengthwise direction thereof and at least one elastic layer disposed on an outside of the shaft member in a radial direction. Also, the conductive elastic roller may be further provided on the surface of the elastic layer with a resin coating layer for the purpose of controlling the charging and adhesion property to toners, preventing the elastic layer from contaminating a photosensitive drum and so on.

As the shaft member of the conductive elastic roller are used various resins such as engineering plastics and so on in addition to metals such as iron, stainless and so on. As the elastic layer of the conductive elastic roller are used various thermosetting resins such as thermosetting urethane resin and so on, and the elastic layer is produced by poring a resin raw material into a mold having a desired cavity form, heating and curing the resin raw material (JP-A-2004-150610). Furthermore, the resin coating layer is formed by dipping a main body of the roller comprising the shaft member and the elastic layer into a solvent-based or a water-based coating liquid or spraying such a coating liquid onto the main roller body, and then drying and curing by heat or hot air.

### DISCLOSURE OF THE INVENTION

However, when the thermosetting urethane resin or the like is used in the elastic layer to produce the conductive elastic roller, it is necessary to heat and cure a resin raw material, so that a large quantity of heat energy is required and a considerable time is also required in the curing. Moreover, there is a problem that much cost for equipment such as a curing furnace or the like is required for conducting the heat curing.

On the contrary, the inventors have made studies on a conductive elastic roller using an ultraviolet-curing type resin in the elastic layer instead of the thermosetting resin, and found that since the ultraviolet-curing type resin is generally high in the hardness, the elastic layer of the conductive elastic roller tends to become hard. When the roller with the elastic layer having a high hardness is used as a developing roller or the like of an image forming apparatus, toners are aggregated or fused due to damages caused by repeatedly subjecting to compressions or frictions between rollers, and a faulty image is easily caused. Therefore, the elastic layer of the conductive elastic roller is required to have a sufficiently low hardness.

On the other hand, when a conductive elastic roller with an elastic layer having a low hardness is used in an image forming apparatus, traces due to pressure-contacting with a photosensitive drum, a blade, a feed roller or the like are easily caused on the surface of the roller. In this case, there is a problem that a stripe-shaped faulty image is easily caused in the formed image. Therefore, the elastic layer of the conductive elastic roller is also required to have a sufficiently small compression residual strain (C set). However, a low-hardness material tends to become large in the compression residual strain, so that it is usually difficult to sufficiently lower and balance both the above-mentioned hardness and compression residual strain.

It is, therefore, the first object of the invention to provide a conductive elastic roller provided with an elastic layer having a low hardness and a small compression residual strain and capable of producing in a short time without requiring a large quantity of heat energy and much cost for equipment.

Also, the inventors have found that an ultraviolet-curing type resin having a usual ion conductive agent dispersed therein is large in the environment dependence of a volume resistivity as a result of studies on the conductive elastic roller using the ultraviolet-curing type resin in the elastic layer. When the roller with the elastic layer having a large environment dependence of the volume resistivity is used as a developing roller or the like for the image forming apparatus, the resistance of the roller is highly changed depending on the environment to easily cause a faulty image. Therefore, the elastic layer of the conductive elastic roller is required to have a sufficiently small environment dependence of the volume resistivity.

It is, therefore, the second object of the invention to provide a conductive elastic roller provided with an elastic layer further having a small environment dependence of a volume resistivity and capable of producing in a short time without requiring a large quantity of heat energy and much cost for equipment.

Furthermore, the inventors have found that an ultraviolet-curing type resin using a usual acrylate monomer is large in the environment dependence of a dimension as a result of studies on the conductive elastic roller using the ultraviolet-curing type resin in the elastic layer. When the roller with the elastic layer having a large environment dependence of a dimension is used as a developing roller or the like for the image forming apparatus, the outer diameter of the roller is highly changed depending on the environment to easily cause a faulty image. Therefore, the elastic layer of the conductive elastic roller is also required to have a sufficiently small environment dependence of the dimension.

It is, therefore, the third object of the invention to provide a conductive elastic roller provided with an elastic layer further having a small environment dependence of a dimension and capable of producing in a short time without requiring a large quantity of heat energy and much cost for equipment.

Moreover, the inventors have found that adhesion property between an elastic layer made of an ultraviolet-curing type resin and a coating layer made of an ultraviolet-curing type resin is usually poor and there is a problem in the durability of the roller as a result of studies on the conductive elastic roller using the ultraviolet-curing type resin in the elastic layer and the coating layer. When the roller having poor adhesion property between the elastic layer and the coating layer is used in the image forming apparatus, the coating layer is easily peeled out from the elastic layer during the use to easily cause a faulty image. Therefore, the elastic layer and the coating layer of the conductive elastic roller are also required to be sufficiently high in the adhesion property.

It is, therefore, the fourth object of the invention to provide a conductive elastic roller further having high adhesion property between an elastic layer and a coating layer and capable of producing in a short time without requiring a large quantity of heat energy and much cost for equipment.

In addition, the inventors have made studies on the conductive elastic roller using the ultraviolet-curing type resin and found that an ultraviolet-curing type resin using a usual urethane acrylate oligomer is high in the staining properties to an adjacent member. When the roller with the elastic layer having high staining properties to the adjacent member is used as a developing roller or the like for the image forming apparatus, the adjacent member such as a photosensitive drum or the like is contaminated to easily cause a faulty image. Therefore, the elastic layer of the conductive elastic roller is also required to have sufficiently small staining properties to the adjacent member.

It is, therefore, the fifth object of the invention to solve the above-mentioned problems of the conventional techniques and to provide a conductive elastic roller provided with an elastic layer further having a low hardness and a small compression residual strain and improving staining properties to an adjacent member and capable of producing a short time without requiring a large quantity of heat energy and much cost for equipment.

The inventors have made various studies in order to achieve the above first object and discovered that a conductive elastic roller provided with an elastic layer having a low hardness and a small compression residual strain and capable of producing in a short time without requiring a large quantity of heat energy and much cost for equipment can be obtained by curing a raw material composition comprising the specified components through ultraviolet irradiation to form the elastic layer.

That is, the first conductive elastic roller according to the invention comprises a shaft member and one or more elastic layers disposed on an outside of the shaft member in a radial direction, and is characterized in that at least one of the elastic layers is composed of an ultraviolet-curing type resin formed by curing a raw material for the elastic layer comprising an urethane acrylate oligomer (A), a photo-polymerization initiator (B) and a conductive agent (C) through ultraviolet irradiation, and the urethane acrylate oligomer (A) is an urethane acrylate oligomer (A1) having a functionality of 1.0-3.0 and a molecular weight of 5,000-100,000.

In the first conductive elastic roller according to the invention, the urethane acrylate oligomer (A1) is preferable to have a polymer chain derived from a polyol having a molecular weight of 500-15,000.

Also, the inventors have made various studies in order to achieve the above second object and discovered that a conductive elastic roller provided with an elastic layer further having a small environment dependence of a volume resistivity and capable of producing in a short time without requiring a large quantity of heat energy and much cost for equipment can be obtained by curing a raw material composition comprising a lithium salt as an ion conductive agent together with an urethane acrylate oligomer and a photo-polymerization initiator through ultraviolet irradiation to form the elastic layer.

That is, the second conductive elastic roller according to the invention comprises a shaft member and one or more elastic layers disposed on an outside of the shaft member in a radial direction, and is characterized in that at least one of the elastic layers is composed of an ultraviolet-curing type resin formed by curing a raw material for the elastic layer comprising an urethane acrylate oligomer (A), a photo-polymerization initiator (B) and a conductive agent (C) through ultraviolet irradiation, and the conductive agent (C) is a lithium salt (C1).

In a preferable embodiment of the second conductive elastic roller according to the invention, the content of the lithium salt (C1) in the raw material for the elastic layer is 0.1-5.0% by mass.

Furthermore, the inventors have made various studies in order to achieve the above third object and discovered that a conductive elastic roller provided with an elastic layer further having a small environment dependence of a dimension and capable of producing in a short time without requiring a large quantity of heat energy and much cost for equipment can be obtained by curing a raw material composition comprising a hydrophobic acrylate monomer of a specified structure together with an urethane acrylate oligomer and a photo-polymerization initiator through ultraviolet irradiation to form the elastic layer.

That is, the third conductive elastic roller according to the invention comprises a shaft member and one or more elastic layers disposed on an outside of the shaft member in a radial direction, and is characterized in that at least one of the elastic layers is composed of an ultraviolet-curing type resin formed by curing a raw material for the elastic layer comprising an urethane acrylate oligomer (A), a photo-polymerization initiator (B), a conductive agent (C) and an acrylate monomer (D) through ultraviolet irradiation, and at least a part of the acrylate monomer (D) is an acrylate monomer (D1) represented by the following general formula (I): 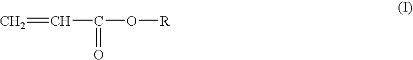
[wherein R is an alkyl group, a cycloalkyl group, an aryl group or an aralkyl group].

In the third conductive elastic roller according to the invention, R in the general formula (I) is preferable to have a carbon number of 12-18. Also, at least a part of the acrylate monomer (D) is particularly preferable to be at least one selected from the group consisting of isomyristyl acrylate, lauryl acrylate and stearyl acrylate.

Moreover, the inventors have made various studies in order to achieve the above fourth object and discovered that a conductive elastic roller further having high adhesion property between an elastic layer and a coating layer and capable of producing in a short time without requiring a large quantity of heat energy and much cost for equipment can be obtained by adding a partial ester of a (metha)acrylate having a hydroxyl group and a polyvalent carboxylic acid to a raw material composition comprising an urethane acrylate oligomer, a photo-polymerization initiator and a conductive agent and then curing the resulting raw material composition for the elastic layer through ultraviolet irradiation to form the elastic layer.

That is, the fourth conductive elastic roller according to the invention comprises a shaft member, one or more elastic layers disposed on an outside of the shaft member in a radial direction and one or more coating layers disposed on an outside of the elastic layer in the radial direction, and is characterized in that at least an outermost layer of the elastic layers is composed of an ultraviolet-curing type resin formed by curing a raw material mixture comprising an urethane acrylate oligomer (A), a photo-polymerization initiator (B) and a conductive agent (C) through ultraviolet irradiation, and the raw material mixture for the outermost layer of the elastic layers further contains a partial ester (E) of a (metha)acrylate having a hydroxyl group and a polyvalent carboxylic acid.

In a preferable embodiment of the fourth conductive elastic roller according to the invention, the partial ester (E) of the (metha)acrylate having the hydroxyl group and the polyvalent carboxylic acid is a monoester of an acrylate having a hydroxyl group and a bivalent carboxylic acid.

In another preferable embodiment of the fourth conductive elastic roller according to the invention, the partial ester (E) of the (metha)acrylate having the hydroxyl group and the polyvalent carboxylic acid is a monoester of at least one selected from the group consisting of 2-hydroxyethyl acrylate, 2-hydroxyethyl methacrylate, 2-hydroxypropyl acrylate, 2-hydroxypropyl methacrylate and pentaerythritol triacrylate and at least one selected from the group consisting of succinic acid, phthalic acid, tetrahydrophthalic acid, methyl tetrahydrophthalic acid, hexahydrophthalic acid, methyl hexahydrophthalic acid, hymic acid and methyl hymic acid.

In the other preferable embodiment of the fourth conductive elastic roller according to the invention, the content of the partial ester (E) in the raw material mixture for the outermost layer of the elastic layers is 1-20% by mass.

In addition, the inventors have made various studies in order to achieve the above fifth object and discovered that a conductive elastic roller provided with an elastic layer further having a low hardness and a small compression residual strain and improving staining properties to an adjacent member and capable of producing a short time without requiring a large quantity of heat energy and much cost for equipment can be obtained by curing a raw material composition comprising an urethane acrylate oligomer synthesized by using the specified raw material, a photo-polymerization initiator and a conductive agent through ultraviolet irradiation to form the elastic layer.

That is, the fifth conductive elastic roller according to the invention comprises a shaft member and one or more elastic layers disposed on an outside of the shaft member in a radial direction, and is characterized in that at least one of the elastic layers is composed of an ultraviolet-curing type resin formed by curing a raw material for the elastic layer comprising an urethane acrylate oligomer (A), a photo-polymerization initiator (B) and a conductive agent (C) through ultraviolet irradiation, and the urethane acrylate oligomer (A) is an urethane acrylate oligomer (A2) synthesized by using as a polyol a high purity polyol satisfying the following equation (II):
y≦0.6/x+0.01 (II)
[wherein x is a hydroxyl value (mg KOH/g) of the polyol and y is a total unsaturation degree (meq/g) of the polyol] alone, or the high purity polyol and another polyol.

In general, a commercially available polyol contains a monool by-product such as one having an unsaturated terminal as an impurity. In the invention, therefore, the purity of the polyol used for the synthesis of the urethane acrylate oligomer (A2) is specified by the total unsaturation degree, and it is necessary to use a polyol wherein the total unsaturation degree (meq/g) and the hydroxyl value (mgKOH/g) satisfy the above equation (II) as at least a part of the polyol. Moreover, the total unsaturation degree and the hydroxyl value of the polyol can be measured according to JIS K 1557:1997.

In a preferable embodiment of the fifth conductive elastic roller according to the invention, the high purity polyol used for the synthesis of the urethane acrylate oligomer (A2) has a molecular weight of 1,000-16,000.

In another preferable embodiment of the fifth conductive elastic roller according to the invention, a mass ratio (a1/a2) of the high purity polyol (a1) to the other polyol (a2) in the polyol used for the synthesis of the urethane acrylate oligomer (A2) is within a range of 100/0-30/70.

In a preferable embodiment of the first, second, fourth and fifth conductive elastic rollers according to the invention, the raw material for the elastic layer further contains an acrylate monomer (D). The acrylate monomer (D) is preferable to have a functionality of 1.0-10 and a molecular weight of 100-2,000.

In another preferable embodiment of the first, third, fourth and fifth conductive elastic rollers according to the invention, the conductive agent (C) is an ion conductive agent (C2).

In the first, second, third and fifth conductive elastic rollers according to the invention, the raw material for the elastic layer used in the ultraviolet-curing type resin is preferable to have a mass ratio (A/D) of the urethane acrylate oligomer (A) to the acrylate monomer (D) of 100/0-10/90 and to contain 0.2-5.0 parts by mass of the photo-polymerization initiator (B) and 0.1-5.0 parts by mass of the conductive agent (C) based on 100 parts by mass of the total amount of the urethane acrylate oligomer (A) and the acrylate monomer (D).

Also, the image forming apparatus according to the invention is characterized by using the above-described conductive elastic roller.

According to the invention, there can be provided the conductive elastic roller provided with the elastic layer(s) having a low hardness and a small compression residual strain capable of producing in a short time without requiring a large quantity of heat energy and much cost for equipment by curing the raw material for the elastic layer comprising the urethane acrylate oligomer (A1) having a functionality of 1.0-3.0 and a molecular weight of 5,000-100,000, the photo-polymerization initiator (B) and the conductive agent (C) through ultraviolet irradiation to form at least one of the elastic layers.

Also, according to the invention, there can be provided the conductive elastic roller provided with the elastic layer(s) further having a small environment dependence of a volume resistivity capable of producing in a short time without requiring a large quantity of heat energy and much cost for equipment by curing the raw material for the elastic layer comprising the urethane acrylate oligomer (A) and the photo-polymerization initiator (B) and further comprising the lithium salt (C1) as an ion conductive agent through ultraviolet irradiation to form at least one of the elastic layers.

Furthermore, according to the invention, there can be provided the conductive elastic roller provided with the elastic layer(s) further having a small environment dependence of a dimension capable of producing in a short time without requiring a large quantity of heat energy and much cost for equipment by curing the raw material for the elastic layer comprising the urethane acrylate oligomer (A), the photo-polymerization initiator (B) and the conductive agent (C) and further containing the hydrophobic acrylate monomer (D1) having the specified structure through ultraviolet irradiation to form at least one of the elastic layers.

Moreover, according to the invention, there can be provided the conductive elastic roller further having high adhesion property between an elastic layer and a coating layer and capable of producing in a short time without requiring a large quantity of heat energy and much cost for equipment by adding the partial ester (E) of the (metha)acrylate having a hydroxyl group and the polyvalent carboxylic acid to the raw material composition comprising the urethane acrylate oligomer (A), the photo-polymerization initiator (B) and the conductive agent (C) and then curing the resulting raw material composition for the elastic layer through ultraviolet irradiation to form at least an outermost layer of the elastic layers.

Also, according to the invention, there can be provided the conductive elastic roller provided with an elastic layer further having a low hardness and a small compression residual strain and improving staining properties to an adjacent member and capable of producing a short time without requiring a large quantity of heat energy and much cost for equipment by curing the raw material for the elastic layer comprising the urethane acrylate oligomer (A2) synthesized by using the high purity polyol satisfying the relation of the equation (II), the photo-polymerization initiator (B) and the conductive agent (C) through ultraviolet irradiation to form at least one of the elastic layers.

In addition, according to the invention, there can be provided the image forming apparatus comprising the above conductive elastic roller and capable of stably forming a good image.

### BRIEF DESCRIPTION OF THE DRAWINGS

FIG. 1 is a sectional view of an embodiment of the conductive elastic roller according to the invention.

FIG. 2 is a sectional view of another embodiment of the conductive elastic roller according to the invention.

FIG. 3 is a partial sectional view of an embodiment of the image forming apparatus according to the invention.

### BEST MODE FOR CARRYING OUT THE INVENTION

<Conductive Elastic Roller>

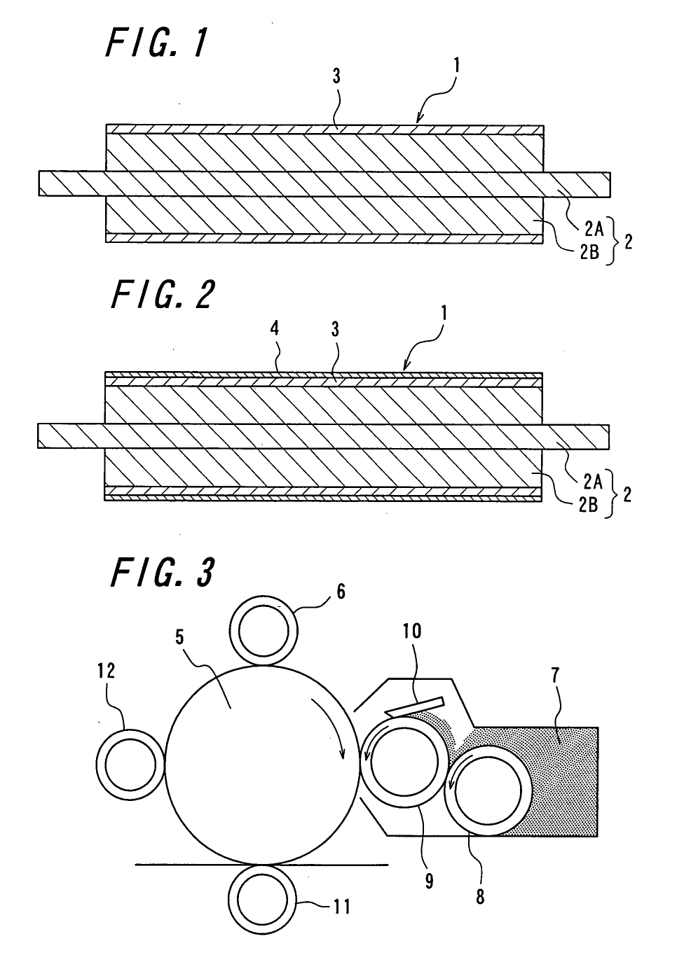

The conductive elastic roller according to the invention will be described in detail below with reference to FIGS. 1 and 2. FIGS. 1 and 2 are sectional views of embodiments of the conductive elastic roller according to the invention. The conductive elastic roller 1 shown in FIG. 1 comprises a shaft member 2 journaled at both ends in a lengthwise direction thereof and an elastic layer 3 disposed on an outside of the shaft member 2 in a radial direction. Also, the conductive elastic roller 1 shown in FIG. 2 comprises a shaft member 2 journaled at both ends in a lengthwise direction thereof, an elastic layer 3 disposed on an outside of the shaft member 2 in a radial direction and a coating layer 4 disposed on an outside of the elastic layer 3 in the radial direction. Although the conductive elastic rollers 1 shown in FIGS. 1 and 2 comprise only one elastic layer 3, the conductive elastic roller according to the invention may comprise two or more elastic layers. Also, the conductive elastic roller 1 shown in FIG. 2 comprises only one coating layer 4, but the conductive elastic roller according to the invention may comprise two or more coating layers.

In FIGS. 1 and 2, the shaft member 2 comprises a metal shaft 2A and a high-stiffness resin base material 2B disposed on the outside of the metal shaft 2A in the radial direction. However, the shaft member of the conductive elastic roller according to the invention is not particularly limited as far as it has a good electrical conductivity, and may be composed of only the metal shaft 2A or only the high-stiffness resin base material 2B, or may be a hollow cylindrical body made of the metal or high-stiffness resin or the like. When the high-stiffness resin is used in the shaft member 2, it is preferable that a conductive agent is added and dispersed into the high-stiffness resin to sufficiently ensure an electrical conductivity. As the conductive agent to be dispersed into the high-stiffness resin are preferable carbon black powder, graphite powder, carbon fiber, metal powder of aluminum, copper, nickel or the like, powder of a metal oxide such as tin oxide, titanium oxide, zinc oxide or the like, and a powdery conductive agent such as conductive glass powder or the like. These conductive agents may be used alone or in a combination of two or more. The amount of the conductive agent compounded is not particularly limited, but is preferable to be within a range of 5-40% by mass, and more preferable to be within a range of 5-20% by mass per the whole of the high-stiffness resin.

As the material of the metal shaft 2A and the metal cylindrical body are mentioned iron, stainless steel, aluminum and so on. Also, as the material of the high-stiffness resin base material 2B are mentioned polyacetal, polyamide 6, polyamide 6-6, polyamide 12, polyamide 4-6, polyamide 6-10, polyamide 6-12, polyamide 11, polyamide MXD6, polybutylene terephthalate, polyphenylene oxide, polyphenylene sulfide, polyether sulfone, polycarbonate, polyimide, polyamide imide, polyether imide, polysulfone, polyether ether ketone, polyethylene terephthalate, polyarylate, liquid crystal polymer, polytetrafluoroethylene, polypropylene, ABS resin, polystyrene, polyethylene, melamine resin, phenol resin, silicone resin and so on. Among them, polyacetal, polyamide 6-6, polyamide MXD6, polyamide 6-12, polybutylene terephthalate, polyphenylene ether, polyphenylene sulfide and polycarbonate are preferable. These high-stiffness resins may be used alone or in a combination of two or more.

When the shaft member is a metal shaft or a shaft formed by disposing a high-stiffness resin base material on the outside of such a metal shaft, the outer diameter of the metal shaft is preferable to be within a range of 4.0-8.0 mm. Also, when the shaft member is the shaft formed by disposing the high-stiffness resin base material on the outside of the metal shaft, the outer diameter of the resin base material is preferable to be within a range of 10-25 mm. Moreover, the mass increase of the shaft member can be suppressed by using the high-stiffness resin in the shaft member, even if the outer diameter of the shaft member becomes large.

In the first, second and fifth conductive elastic rollers according to the invention, at least one of the elastic layers 3 is composed of an ultraviolet-curing type resin formed by curing a raw material for the elastic layer comprising an urethane acrylate oligomer (A), a photo-polymerization initiator (B) and a conductive agent (C) through ultraviolet irradiation. In the third conductive elastic roller according to the invention, at least one of the elastic layers 3 is composed of an ultraviolet-curing type resin formed by curing a raw material for the elastic layer comprising an urethane acrylate oligomer (A), a photo-polymerization initiator (B), a conductive agent (C) and an acrylate monomer (D) through ultraviolet irradiation. In the fourth conductive elastic roller according to the invention, at least one of the elastic layers 3 is composed of an ultraviolet-curing type resin formed by curing a raw material mixture comprising an urethane acrylate oligomer (A), a photo-polymerization initiator (B), a conductive agent (C) and a partial ester (E) of a (metha)acrylate having a hydroxyl group and a polyvalent carboxylic acid through ultraviolet irradiation. Moreover, various additives may be compounded into the raw materials for the elastic layer as far as they do not obstruct the object of the invention.

The urethane acrylate oligomer (A) is a compound having one or more acryloyloxy group (CH₂═CHCOO—) and plural urethane linkages (—NHCOO—). For example, the urethane acrylate oligomer (A) can be produced by synthesizing an urethane prepolymer from a polyol and a polyisocyanate and adding an acrylate having a hydroxyl group to the urethane prepolymer.

The polyol used for the synthesis of the urethane prepolymer is a compound having plural hydroxyl groups (OH groups). As the polyol are concretely mentioned polyether polyol, polyester polyol, polytetramethylene glycol, polybutadiene polyol, alkylene oxide-modified polybutadiene polyol, polyisoprene polyol and so on. The polyether polyol can be obtained, for example, by adding an alkylene oxide such as ethylene oxide, propylene oxide or the like to a polyalcohol such as ethylene glycol, propylene glycol, glycerin or the like. Also, the polyester polyol can be obtained, for example, from a polyalcohol such as ethylene glycol, diethylene glycol, 1,4-butanediol, 1,6-hexanediol, propylene glycol, trimethylolethane, trimethylolpropane or the like and a polyvalent carboxylic acid such as adipic acid, glutaric acid, succinic acid, sebacic acid, pimelic acid, suberic acid or the like. These polyols may be used alone or in a combination of two or more.

The polyisocyanate is a compound having plural isocyanate groups (NCO groups). As the polyisocyanate are concretely mentioned tolylene diisocyanate (TDI), diphenylmethane diisocyanate (MDI), crude diphenylmethane diisocyanate (crude MDI), isophorone diisocyanate (IPDI), hydrogenated diphenylmethane diisocyanate, hydrogenated tolylene diisocyanate and hexamethylene diisocyanate (HDI), as well as their isocyanurate-modified compounds, carbodiimide-modified compounds, glycol-modified compounds and so on. These polyisocyanates may be used alone or in a combination of two or more.

In the synthesis of the urethane prepolymer, it is preferable to use a catalyst for urethanation reaction. As the catalyst for urethanation reaction are concretely mentioned organotin compounds such as dibutyltin dilaurate, dibutyltin diacetate, dibutyltin thiocarboxylate, dibutyltin dimaleate, dioctyltin thiocarboxylate, tin octoate, monobutyl tin oxide and the like; inorganotin compounds such as stannous chloride and the like; organolead compounds such as lead octoate and the like; monoamines such as triethylamine, dimethyl cyclohexylamine and the like; diamines such as tetramethyl ethylenediamine, tetramethyl propanediamine, tetramethyl hexanediamine and the like; triamines such as pentamethyl diethylenetriamine, pentamethyl dipropylenetriamine, tetramethylguanidine and the like; cyclic amines such as triethylenediamine, dimethyl piperazine, methyl ethyl piperazine, methyl morpholine, dimethyl aminoethyl morpholine, dimethyl imidazole, pyridine and the like; alcohol amines such as dimethylaminoethanol, dimethylaminoethoxyethanol, trimethylaminoethyl ethanolamine, methyl hydroxyethyl piperazine, hydroxyethyl morpholine and the like; ether amines such as bis(dimethylaminoethyl)ether, ethyleneglycol bis(dimethyl)aminopropyl ether and the like; organosulfonic acids such as p-toluene sulfonic acid, methane sulfonic acid, fluorosulfuric acid and the like; inorganic acids such as sulfuric acid, phosphoric acid, perchloric acid and the like; bases such as sodium alcoholate, lithium hydroxide, aluminum alcoholate, sodium hydroxide and the like; titanium compounds such as tetrabutyl titanate, tetraethyl titanate, tetraisopropyl titanate and the like; bismuth compounds; quaternary ammonium salts and the like. Among these catalysts, the organotin compounds are preferable. These catalysts may be used alone or in a combination of two or more. The amount of the catalyst used is preferable to be within a range of 0.001-2.0 parts by mass based on 100 parts by mass of the polyol.

Moreover, the acrylate having a hydroxyl group added to the urethane prepolymer is a compound having one or more hydroxyl group and one or more acryloyloxy group (CH₂═CHCOO—). The acrylate having the hydroxyl group can be added to the isocyanate group of the urethane prepolymer. As the acrylate having the hydroxyl group are mentioned 2-hydroxyethyl acrylate, 2-hydroxypropyl acrylate, pentaerythritol triacrylate and so on. These acrylates having the hydroxyl group may be used alone or in a combination of two or more.

In the first conductive elastic roller according to the invention, the urethane acrylate oligomer (A) is an urethane acrylate oligomer (A1) having a functionality of 1.0-3.0, preferably 1.5-2.5 and a molecular weight of 5,000-100,000. The functional group herein means an acryloyloxy group. Moreover, the molecular weight is a number average molecular weight as converted to polystyrene. When the functionality of the urethane acrylate oligomer (A1) is less than 1.0, there is a possibility that the unreacted urethane acrylate oligomer remains in the elastic layer to contaminate a photosensitive drum or the like but also the compression residual strain is increased to easily cause a faulty image, while when it exceeds 3.0, the curing through ultraviolet rays excessively progresses, and hence the hardness of the elastic layer is significantly increased. Also, when the molecular weight of the urethane acrylate oligomer (A1) is less than 5,000, the hardness of the elastic layer may be excessively high, while when it exceeds 100,000, the compression residual strain of the elastic layer may be excessively large.

In the synthesis of the urethane prepolymer for the urethane acrylate oligomer (A1), the polyol to be used is preferable to have a molecular weight of 500-15,000. When the molecular weight of the polyol is less than 500, the hardness becomes higher and it is not suitable for the elastic layer of the conductive elastic roller, while when it exceeds 15,000, the compression residual strain is increased to easily cause a faulty image.

In the synthesis of the urethane prepolymer for the urethane acrylate oligomer (A1), a ratio of the polyol to the isocyanate can be properly selected for any purpose. In the urethane prepolymer, an isocyanate index is preferably within a range of 110-200, more preferably within a range of 115-200. The isocyanate index is a value calculated from the following equation:
(Isocyanate index)=(B/A)×100
[wherein A is the number of OH groups in the polyol and B is the number of NCO groups in the isocyanate]. When the isocyanate index of the urethane prepolymer is less than 110, the compression residual strain is increased to easily cause a faulty image, while when it exceeds 200, the isocyanate not reacting with the polyol is increased to deteriorate properties.

In the fifth conductive elastic roller according to the invention, the urethane acrylate oligomer (A) is an urethane acrylate oligomer (A2) synthesized by using as a polyol a high purity polyol satisfying the equation (II) alone, or the high purity polyol and another polyol. The urethane acrylate oligomer (A2) can be synthesized, for example, by (i) adding an acrylate having a hydroxyl group to an urethane prepolymer synthesized from the high purity polyol alone or a mixture of the high purity polyol and another polyol and a polyisocyanate, or by (ii) adding an acrylate having a hydroxyl group to a mixture of an urethane prepolymer synthesized from the high purity polyol alone or a mixture of the high purity polyol and another polyol and a polyisocyanate and an urethane prepolymer synthesized from another polyol and a polyisocyanate. Moreover, the high purity polyol used for the synthesis of the urethane prepolymer can be synthesized, for example, by adding an alkylene oxide such as propylene oxide (PO), ethylene oxide (EO) or the like to a polyalcohol such as ethylene glycol, propylene glycol, glycerin, neopentylglycol, trimethylolpropane, pentaerythritol, a compound obtained by reacting them with an alkylene oxide in the presence of a catalyst such as diethyl zinc, iron chloride, metal porphyrin, a composite metal cyanide complex, a cesium compound or the like, and is less in the amount of a monool by-product such as one having an unsaturated terminal or the like and has a purity higher than that of the conventional polyol.

When the elastic layer is formed through ultraviolet irradiation using a common urethane acrylate oligomer, the staining properties to the adjacent member of the roller is high. Surprisingly, when the elastic layer is formed through ultraviolet irradiation using the urethane acrylate oligomer (A2) synthesized with the high purity polyol satisfying the equation (II), the staining properties to the adjacent member of the roller can be reduced while decreasing the compression residual strain. This is considered due to the fact that the curability of the raw material for the elastic layer containing the urethane acrylate oligomer (A2) synthesized with the high purity polyol through ultraviolet rays is higher than that of the raw material for the elastic layer containing the common urethane acrylate oligomer through ultraviolet rays. If the elastic layer is formed by using an urethane acrylate oligomer synthesized with only a polyol not satisfying the equation (II) as a polyol, the staining properties to the adjacent member of the roller cannot be sufficiently reduced and also the compression residual strain of the elastic layer cannot be decreased sufficiently, so that traces due to pressure-contacting with the adjacent member are left on the roller to easily cause a faulty image. Moreover, from a viewpoint of reducing the staining properties to the adjacent member of the roller while decreasing the compression residual strain set, the high purity polyol preferably has a total unsaturation degree of not more than 0.05 meq/g, more preferably not more than 0.025 meq/g and even more preferably not more than 0.01 meq/g.

The high purity polyol used for the synthesis of the urethane acrylate oligomer (A2) is preferable to have a molecular weight of 1,000-16,000. The molecular weight herein means a weight average molecular weight (Mw). When the molecular weight of the high purity polyol is less than 1,000, the hardness of the resin becomes high and an image is deteriorated and the resin is not suitable as the material of the elastic roller, while when it exceeds 16,000, the compression residual strain is increased to deform the roller and easily cause a faulty image.

Also, another polyol which may be used together with the high purity polyol in the synthesis of the urethane acrylate oligomer (A2) is a compound having plural hydroxyl groups (OH groups) and is not particularly limited and the above-described common polyol can be used. When the other polyol (a2) is used together with the high purity polyol (a1) in the synthesis of the urethane acrylate oligomer (A2), the mass ratio (a1/a2) of the high purity polyol (a1) to the other polyol (a2) is preferable to be within a range of 100/0-30/70. The staining properties to the adjacent member such as a photosensitive drum or the like of the conductive elastic roller can be sufficiently reduced while decreasing the compression residual strain of the elastic layer by rendering a ratio of the high purity polyol (a1) in a total amount (a1+a2) of the high purity polyol (a1) and the other polyol (a2) into not less than 30% by mass (i.e. rendering a ratio of the other polyol (a2) into not more than 70% by mass).

The photo-polymerization initiator (B) has an action of initiating polymerization of the above-mentioned urethane acrylate oligomer (A) or further polymerization of the acrylate monomer (D) and the partial ester (E) described below through ultraviolet irradiation. As the photo-polymerization initiator (B) are mentioned 4-dimethylaminobenzoic acid, 4-dimethylaminobenzoic ester, 2,2-dimethoxy-2-phenylacetophenone, acetophenone diethylketal, alkoxyacetophenone, benzyldimethylketal, benzophenone, benzophenone derivatives such as 3,3-dimethyl-4-methoxy benzophenone, 4,4-dimethoxy benzophenone, 4,4-diamino benzophenone and the like, alkyl benzoylbenzoate, bis(4-dialkylaminophenyl)ketone, benzyl, benzyl derivatives such as benzyl methylketal and the like, benzoin, benzoin derivatives such as benzoin isobutyl ether and the like, benzoin isopropyl ether, 2-hydroxy-2-methyl propiophenone, 1-hydroxycyclohexyl phenylketone, xanthone, thioxanthone, thioxanthone derivatives, fluorene, 2,4,6-trimethylbenzoyldiphenylphosphine oxide, bis(2,6-dimethoxybenzoyl)-2,4,4-trimethylpentylphosphine oxide, bis(2,4,6-trimethylbenzoyl)-phenylphosphine oxide, 2-methyl-1-[4-(methylthio)phenyl]-2-morpholinopropanone-1,2-benzyl-2-dimethylamino-1-(morpholinophenyl)-butanone-1 and the like. These photo-polymerization initiators may be used alone or in a combination of two or more.

The conductive agent (C) has an action of giving an electric conductivity to the elastic layer. As the conductive agent (C) are preferable ones permeable to ultraviolet rays, and it is preferable to use an ion conductive agent and a transparent electron conductive agent, and the use of the ion conductive agent is preferable. When the ion conductive agent is used as the conductive agent (C), since the ion conductive agent is soluble in the urethane acrylate oligomer (A) and has a transparency, even if the raw material for the elastic layer is thickly applied on the shaft member, ultraviolet rays can sufficiently reach an inside of the coating to sufficiently cure the raw material for the elastic layer. As the ion conductive agent are mentioned ammonium salts such as perchlorate, chlorate, hydrochloride, bromate, iodate, hydroborofluoride, sulfate, ethylsulfate, carboxylate and sulfonate of tetraethyl ammonium, tetrabutyl ammonium, dodecyltrimethyl ammonium, hexadecyltrimethyl ammonium, benzyltrimethyl ammonium and modified-fatty acid dimethylethyl ammonium and the like; perchlorate, chlorate, hydrochloride, bromate, iodate, hydroborofluoride, sulfate, trifluoromethyl sulfate and sulfonate of an alkali metal or an alkali earth metal such as lithium, sodium, potassium, calcium, magnesium or the like. Moreover, as the transparent electron conductive agent are mentioned microparticles of metal oxides such as ITO, tin oxide, titanium oxide, zinc oxide and the like; microparticles of metals such as nickel, copper, silver, germanium and the like; conductive whiskers such as conductive titanium oxide whisker, conductive barium titanate whisker and the like. These conductive agents may be used alone or in a combination of two or more.

In the second conductive elastic roller according to the invention, the conductive agent (C) is a lithium salt (C1). Since the lithium salt (C1) has a small environment dependence in the effect of giving the electric conductivity, it can reduce an environment dependence in the volume resistivity of the elastic layer. Also, since the lithium salt is soluble in the urethane acrylate oligomer (A) and has a transparency, even if the raw material for the elastic layer is thickly applied on the shaft member, ultraviolet rays can sufficiently reach an inside of the coating to sufficiently cure the raw material for the elastic layer. The lithium salt may be a salt of an organic acid such as sulfonic acid, trifluoromethanesulfonic acid or the like, or a salt of an inorganic acid such as perchloric acid, tetrafluoroboric acid or the like. As the lithium salt are mentioned Li(CF₃SO₂)₂N, Li(C₂F₅SO₂)₂N, LiClO₄, LiBF₄, LiPF₆, LiCF₃SO₃, LiAsF₆, LiC₄F₉SO₃ and so on. Among them, Li(CF₃SO₂)₂N is preferable. These lithium salts (C1) may be used alone or in a combination of two or more. The lithium salt (C1) may be dissolved in various solvents and mixed with the raw material for the elastic layer. As the solvent dissolving the lithium salt (C1) are preferably used ones not damaging the object of the invention, and it is preferable to use, for example, the polyol used for the synthesis of the above-mentioned urethane acrylate oligomer (A), the acrylate monomer (D) mentioned below or the like.

In the third conductive elastic roller according to the invention, the raw material for the elastic layer further contains the acrylate monomer (D). Also, the raw material for the elastic layer is preferable to further contain the acrylate monomer (D) in the first, second, fourth and fifth conductive elastic rollers according to the invention. The acrylate monomer (D) is a monomer having one or more acryloyloxy groups (CH₂═CHCOO—) and serves as a reactive diluent, i.e., it is cured through ultraviolet rays and can lower the viscosity of the raw material for the elastic layer. The acrylate monomer (D) preferably has a functionality of 1.0-10, and more preferably 1.0-3.5. The functional group herein means the acryloyloxy group. When the functionality of the acrylate monomer (D) is not less than 1.0, the unreacted acrylate monomer hardly remains in the elastic layer, while when it is not more than 10, the hardness of the elastic layer dose not become excessively high.

Furthermore, the acrylate monomer (D) is preferable to have a molecular weight of 100-2000, more preferably 100-1000. When the molecular weight of the acrylate monomer (D) is not less than 100, a resin having a low hardness and suitable for the elastic layer of the conductive elastic roller can be easily obtained, while when it is not more than 2000, a resin having a small compression residual strain can be easily obtained.

As the acrylate monomer (D) are mentioned methoxytriethyleneglycol acrylate, ethyl acrylate, isobutyl acrylate, n-butyl acrylate, isoamyl acrylate, glycidyl acrylate, butoxyethyl acrylate, ethoxydiethyleneglycol acrylate, methoxydipropyleneglycol acrylate, phenoxyethyl acrylate, 2-hydroxyethyl acrylate, 2-hydroxypropyl acrylate, pentaerythritol acrylate and so on. These acrylate monomers may be used alone or in a combination of two or more.

In the third conductive elastic roller according to the invention, at least a part of the acrylate monomer (D) is an acrylate monomer (D1) represented by the general formula (I) and may contain another acrylate monomer (D2), if necessary. The acrylate monomer (D1) of the formula (I) is more hydrophobic than the common acrylate monomer and hardly absorbs moisture. Therefore, the environment dependence in the dimension of the elastic layer can be reduced by compounding the acrylate monomer (D1) represented by the formula (I) into the raw material for the elastic layer. Moreover, the acrylate monomer (D1) serves as a reactive diluent, i.e., it is cured through ultraviolet rays and can lower the viscosity of the raw material for the elastic layer. The acrylate monomers (D1) may be used alone or in a combination of two or more.

R in the general formula (I) is an alkyl group, a cycloalkyl group, an aryl group or an aralkyl group and preferably has a carbon number of 12-18. The alkyl group includes dodecyl group, tridecyl group, tetradecyl group, pentadecyl group, hexadecyl group, heptadecyl group, octadecyl group and so on, and may be linear or branched. As the cycloalkyl group are mentioned octylcyclopentyl group, octylcyclohexyl group, decylcyclopentyl group, decylcyclohexyl group, dodecylcyclopentyl group, dodecylcyclohexyl group and so on. As the aryl group are mentioned hexylphenyl group, ethylnaphthyl group, nonylphenyl group, pentylnaphthyl group, dodecylphenyl group, octylnaphthyl group and so on. As the aralkyl group are mentioned phenylhexyl group, phenylnonyl group, phenyldodecyl group and so on.

As the acrylate monomer (D1) of the formula (I) are concretely mentioned lauryl acrylate, isomyristyl acrylate, stearyl acrylate, myristyl acrylate, palmityl acrylate, ethyl acrylate, isobutyl acrylate, n-butyl acrylate, isoamyl acrylate, isobornyl acrylate, isooctyl acrylate and so on. Among them, isomyristyl acrylate, lauryl acrylate and stearyl acrylate are preferable.

The other acrylate monomer (D2) which can be used together with the acrylate monomer (D1) of the formula (I) is not particularly limited and the above-described common acrylate monomer can be used. In the raw material for the elastic layer, the amount of the acrylate monomer (D1) of the formula (I) is preferable to be within a range of 1-90 parts by mass based on 100 parts by mass of a total amount of the urethane acrylate oligomer (A) and the acrylate monomer (D). When a ratio of the acrylate monomer (D1) in the total amount of the urethane acrylate oligomer (A) and the acrylate monomer (D) is not less than 1% by mass (i.e., a ratio of the urethane acrylate oligomer (A) and the other acrylate monomer (D2) is not more than 99% by mass), the environment dependence in the dimension of the elastic layer can be reduced, while when the ratio of the acrylate monomer (D1) is not more than 90% by mass (i.e., the ratio of the urethane acrylate oligomer (A) and the other acrylate monomer (D2) is not less than 10% by mass), there can be obtained the elastic layer suitable for the conductive elastic roller having a low hardness and a small compression residual strain.

In the fourth conductive elastic roller according to the invention, the raw material mixture for the outermost layer of the elastic layers contains a partial ester (E) of a (metha)acrylate having a hydroxyl group and a polyvalent carboxylic acid. The partial ester (E) has one or more (metha)acryloyloxy group, one or more carboxyl group and an effect of improving the adhesion property to the coating layer. Also, the partial ester (E) serves as a reactive diluent, i.e., it can be cured through ultraviolet rays to lower the viscosity of the raw material mixture. The partial esters (E) may be used alone or in a combination of two or more.

For example, the partial ester (E) of the (metha)acrylate having the hydroxyl group and the polyvalent carboxylic acid is not particularly limited, but can be produced by partially esterifying a (metha)acrylate having a hydroxyl group and represented by the following general formula (III): 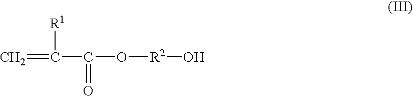
[wherein R¹ is hydrogen or methyl group, and R² is a bivalent group] and a polyvalent carboxylic acid represented by the following general formula (IV):
R³ [symbol] COOH)ₙ (IV)
[wherein n is an integer of not less than 2, and R³ is a group having a valency of n], and in this case, a partial ester represented by the following general formula (V): 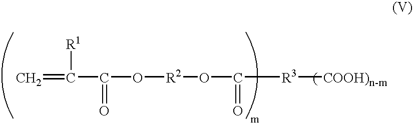
[wherein each of R¹, R², R³ and n is the same meaning as mentioned above, and m is an integer of not less than 1 but not more than (n−1)] is produced.

As the partial ester (E) is preferable a monoester of an acrylate having a hydroxyl group and a bivalent carboxylic acid, that is, R¹ is preferable to be hydrogen, n is preferable to be 2 and m is preferable to be 1. As R² are mentioned ethylene group, trimethylene group, propylene group, tetramethylene group, bis(acryloyloxymethyl)ethylene group and so on. As R³ are mentioned ethylene group, phenylene group, cyclohexenylene group, methylcyclohexenylene group, cyclohexylene group, methylcyclohexylene group, norbornenediyl group, methylnorbornenediyl group and so on.

As the (metha)acrylate having the hydroxyl group are mentioned 2-hydroxyethyl(metha)acrylate, 2-hydroxypropyl (metha)acrylate, pentaerythritol triacrylate and so on. Among them, 2-hydroxyethyl acrylate is preferable.

As the polyvalent carboxylic acid are mentioned succinic acid, phthalic acid, tetrahydrophthalic acid, methyl tetrahydrophthalic acid, hexahydrophthalic acid, methyl hexahydrophthalic acid, hymic acid, methyl hymic acid and so on. Among them, succinic acid is preferable.

As the partial ester (E) of the (metha)acrylate having the hydroxyl group and the polyvalent carboxylic acid are mentioned β-(metha)acryloyloxyethyl hydrogen succinate, β-(metha)acryloyloxypropyl hydrogen succinate, β-(metha)acryloyloxyethyl hydrogen phthalate, β-(metha)acryloyloxypropyl hydrogen phthalate, β-(metha)acryloyloxyethyl hydrogen tetrahydrophthalate, β-(metha)acryloyloxypropyl hydrogen tetrahydrophthalate, β-(metha)acryloyloxyethyl hydrogen hexahydrophthalate, β-(metha)acryloyloxypropyl hydrogen hexahydrophthalate, β-tris(acryloyloxymethyl)ethyl hydrogen phthalate and so on. Among them, β-acryloyloxyethyl hydrogen succinate is preferable.

In the raw material for the elastic layer, the mass ratio (A/D) of the urethane acrylate oligomer (A) to the acrylate monomer (D) is preferable to be within a range of 100/0-10/90. When the ratio of the urethane acrylate oligomer (A) in the total amount of the urethane acrylate oligomer (A) and the acrylate monomer (D) is not less than 10% by mass (i.e., the ratio of the acrylate monomer (D) is not more than 90% by mass), a resin having a small compression residual strain can be obtained.

In the first, second, third and fifth conductive elastic rollers according to the invention, the amount of the photo-polymerization initiator (B) compounded is preferable to be within a range of 0.2-5.0 parts by mass based on 100 parts by mass of the total amount of the urethane acrylate oligomer (A) and the acrylate monomer (D). Also, in the fourth conductive elastic roller according to the invention, the amount of the photo-polymerization initiator (B) compounded is preferable to be within a range of 0.2-5.0 parts by mass based on 100 parts by mass of the total amount of the urethane acrylate oligomer (A), the acrylate monomer (D) and the partial ester (E). When the amount of the photo-polymerization initiator (B) compounded is less than 0.2 part by mass, the effect of initiating the ultraviolet curing of the raw material for the elastic layer is small, while when it exceeds 5.0 parts by mass, the effect of initiating the ultraviolet curing is saturated, and the properties such as compression residual strain and so on are deteriorated and the cost of the raw material for the elastic layer becomes high.

In the first, second, third and fifth conductive elastic rollers according to the invention, the amount of the conductive agent (C) compounded in the raw material for the elastic layer is preferable to be within a range of 0.1-5.0 parts by mass based on 100 parts by mass of the total amount of the urethane acrylate oligomer (A) and the acrylate monomer (D). Also, in the fourth conductive elastic roller according to the invention, the amount of the conductive agent (C) compounded in the raw material for the outermost layer of the elastic layers is preferable to be within a range of 0.1-5.0 parts by mass based on 100 parts by mass of the total amount of the urethane acrylate oligomer (A), the acrylate monomer (D) and the partial ester (E). When the amount of the conductive agent (C) compounded is less than 0.1 part by mass, the electric conductivity of the elastic layer is low and the desired electric conductivity may not be given to the conductive elastic roller, while when it exceeds 5.0 parts by mass, the electric conductivity of the elastic layer does not become high, and the properties such as compression residual strain and so on are deteriorated and a good image may not be obtained.

In the first, second, third and fifth conductive elastic rollers according to the invention, 0.001-0.2 part by mass of a polymerization inhibitor may be further added to the raw material for the elastic layer based on 100 parts by mass of the total amount of the urethane acrylate oligomer (A) and the acrylate monomer (D). Also, in the fourth conductive elastic roller according to the invention, 0.001-0.2 part by mass of the polymerization inhibitor may be further added to the raw material for the elastic layer based on 100 parts by mass of the total amount of the urethane acrylate oligomer (A), the acrylate monomer (D) and the partial ester (E). The thermal polymerization before the irradiation of ultraviolet rays can be prevented by adding the polymerization inhibitor. As the polymerization inhibitor are mentioned hydroquinone, hydroquinone monomethyl ether, p-methoxyphenol, 2,4-dimethyl-6-t-butylphenol, 2,6-di-t-butyl-p-cresol, butyl hydroxy anisole, 3-hydroxythiophenol, α-nitroso-β-naphthol, p-benzoquinone, 2,5-dihydroxy-p-quinone and so on.

The coating layer 4 of the conductive elastic roller according to the invention is preferable to be composed of an ultraviolet-curing type resin obtained by curing a raw material mixture comprising an urethane acrylate oligomer and a photo-polymerization initiator through ultraviolet irradiation. As the urethane acrylate oligomer and the photo-polymerization initiator can be used the same as used in the elastic layer 3, and the compounding ratio thereof may be also the same. Also, the raw material mixture for the coating layer may be compounded with various additives without damaging the object of the invention. As the additive are mentioned an acrylate monomer, a conductive agent, a microparticle and so on. As the acrylate monomer and the conductive agent can be used the same as used in the elastic layer, and the compounding ratio thereof may be also the same. As the microparticle are preferable microparticles of a rubber, an urethane or a synthetic resin and inorganic microparticles such as carbon microparticles, silica-based microparticles. Particularly, microparticles of silicone rubber, silicone resin, fluorocarbon resin, urethane resin, polyolefin resin, epoxy resin, polystyrene resin, urethane acrylate, melamine resin, phenol resin, (metha)acrylic-based resin and glassy carbon, and silica microparticles are preferable. On the surface of the conductive elastic roller can be properly formed a micro-unevenness by compounding the microparticle into the raw material mixture for the coating layer. These microparticles may be used alone or in a combination of two or more. Moreover, the content of the microparticle is preferable to be within a range of 0.1-100 parts by mass based on 100 parts by mass of the total amount of the urethane acrylate oligomer and the acrylate monomer.

The elastic layer is preferable to have an Asker C hardness of 30 degrees to 70 degrees. The Asker C hardness herein is a value measured on a plane part of a cylindrical sample having a height of 12.7 mm and a diameter of 29 mm. When the Asker C hardness is not less than 30 degrees, a sufficient hardness as the conductive elastic roller such as a developing roller or the like can be ensured, while when it is not more than 70 degrees, the aggregation and fusion of toners having a low melting point can be sufficiently prevented.

The elastic layer is preferable to have a compression residual strain (compression set) of not more than 5%. The compression residual strain can be measured according to JIS K 6262 (2006). Concretely, it can be determined by compressing a cylindrical sample having a height of 12.7 mm and a diameter of 29 mm by 25% in a height direction of the sample under the predetermined heat-treating conditions (at 70° C. for 22 hours). When the compression residual strain of the elastic layer is not more than 5%, if the conductive elastic roller is incorporated as a developing roller into an image forming apparatus, traces due to pressure-contacting with a photosensitive drum, a blade, a feeding roller or the like are hardly caused on the surface of the roller and a stripe-shaped faulty image is hardly caused.

The elastic layer is preferable to have a volume resistivity of 10⁴-10¹⁰ Ωcm. When the volume resistivity of the elastic layer is less than 10⁴ Ωcm, if the roller is used as a developing roller, charge may leak to the photosensitive drum and so on, or the roller itself may be broken due to the voltage, while when it exceeds 10¹⁰ Ωcm, fogging is easily caused.

The elastic layer is preferable to have a thickness of 1-3000 μm. When the thickness of the elastic layer is not less than 1 μm, the conductive elastic roller has a sufficient elasticity and the damage to toners is sufficiently small, while when it is not more than 3000 μm, ultraviolet rays irradiated can sufficiently reach a deep portion of the elastic layer to surely cure the raw material for the elastic layer, and the amount of the expensive ultraviolet-curing resin material used can be decreased.

In the conductive elastic roller according to the invention, it is preferable that the resistance of the roller is 10⁴-10¹⁰ Ω at an applied voltage of 100 V. For example, in case of using the conductive elastic roller as a developing roller, when the resistance value of the conductive elastic roller is not less than 10⁴Ω, the control of tone is easy and also a bias leakage is hardly caused even if defects are existent in the photosensitive drum or the like, while when it is not more than 10¹⁰Ω, if toners are developed on the photosensitive drum or the like, it is possible to ensure a developing bias sufficient for the development without causing voltage drop due to the resistance of the conductive elastic roller itself, and as a result, a sufficient image density can be obtained. The resistance value can be determined from a current value obtained by pushing the outer peripheral surface of the conductive elastic roller onto a plate-like or cylindrical counter electrode under a predetermined pressure and applying a voltage of 100 V between the shaft and the counter electrode. Moreover, it is important to properly and evenly control the resistance value of the conductive elastic roller from a viewpoint that an electric field intensity is properly and uniformly maintained for transferring toners.

The conductive elastic roller according to the invention can be prepared, for example, by applying the raw material mixture for the elastic layer onto the outer surface of the shaft member, irradiating ultraviolet rays, and then optionally applying the raw material mixture for the coating layer on the outer surface of the resulting elastic layer and irradiating ultraviolet rays. In the conductive elastic roller according to the invention, therefore, it is possible to prepare the elastic layer in a short time without requiring a large quantity of heat energy in the preparation of the elastic layer. Also, a curing furnace or the like is not required for the formation of the elastic layer, so that much cost for equipment is also not required. As the method for applying the raw material for the elastic layer onto the outer surface of the shaft member are mentioned a spraying method, a roll-coating method, a dipping method, a die coating method and the like. As a light source used for the ultraviolet irradiation are mentioned a mercury vapor lamp, a high pressure mercury vapor lamp, a super high pressure mercury vapor lamp, a metal halide lamp, a xenon lamp and the like. The conditions for the ultraviolet irradiation are properly selected depending on the components included in the raw material mixture for the elastic layer, the composition, the amount applied and the like, i.e. the irradiation intensity, integral light quantity and so may be adjusted properly.

The above-mentioned conductive elastic rollers according to the invention can be used as a developing roller, a charging roller, a toner feed roller, a transfer roller, a paper feed roller, a cleaning roller, a pressure roller for fixing or the like in an image forming apparatus, and are particularly preferable as the developing roller and the charging roller.

<Image Forming Apparatus>

The image forming apparatus according to the invention is characterized by comprising the above-mentioned conductive elastic roller and preferably as at least one of the developing roller and the charging roller. The image forming apparatus according to the invention is not particularly limited as far as it comprises the conductive elastic roller, and can be manufactured according to the known method.

The image forming apparatus according to the invention will be described in detail below with reference to FIG. 3. FIG. 3 is a partial sectional view of an embodiment of the image forming apparatus according to the invention. The illustrated image forming apparatus comprises a photosensitive drum 5 carrying an electrostatic latent image, a charging roller 6 positioned near to the photosensitive drum 5 (upside in the figure) for charging the photosensitive drum 5, a toner feed roller 8 for supplying toners 7, a developing roller 9 disposed between the toner feed roller 8 and the photosensitive drum 5, a stratification blade 10 disposed near to the developing roller 9 (upside in the figure), a transfer roller 11 positioned near to the photosensitive drum 5 (downside in the figure), and a cleaning roller 12 disposed adjacent to the photosensitive drum 5. Moreover, the image forming apparatus according to the invention may further comprise known members (not shown) usually used for the image forming apparatus.

In the illustrated image forming apparatus, the charging roller 6 is contacted with the photosensitive drum 5, and a voltage is applied between the photosensitive drum 5 and the charging roller 6 to charge the photosensitive drum 5 at a constant electric potential, and then an electrostatic latent image is formed on the photosensitive drum 5 by an exposure machine (not shown). Then, the toners 7 are supplied from the toner feed roller 8 to the photosensitive drum 5 through the developing roller 9 by rotating the photosensitive drum 5, the toner feed roller 8 and the developing roller 9 in the direction shown by arrows in the figure. The toners 7 on the developing roller 9 are made to be a uniform thin layer by the stratification blade 10, while since the developing roller 9 and the photosensitive drum 5 are rotated in contact with each other, the toners 7 are attached from the developing roller 9 to the electrostatic latent image on the photosensitive drum 5 to visualize the latent image. The toners 7 attached to the latent image are transferred to a recording medium such as a paper or the like by the transfer roller 11, while the remaining toners 7 on the photosensitive drum 5 after the transferring are removed by the cleaning roller 12. In the image forming apparatus according to the invention, it is possible to stably form an excellent image by using the above-mentioned conductive elastic roller of the invention as at least one of the charging roller 6, the toner feed roller 8, the developing roller 9, the transfer roller 11 and the cleaning roller 12, and preferably as at least one of the charging roller 6 and the developing roller 9.

### EXAMPLES

The following examples are given in illustration of the invention and are not intended as limitations thereof.

<First Conductive Elastic Roller>

### Example 1-1)

100 parts by mass of bifunctional polyoxypropylene glycol having a molecular weight of 3200, 10.4 parts by mass of isophorone diisocyanate (isocyanate index=150) and 0.01 part by mass of dibutyltin dilaurate are reacted at 70° C. for 2 hours with stirring to synthesize an urethane prepolymer having isocyanate groups at both ends of its molecular chain. The resulting urethane prepolymer has a NCO group content of 1.19%. Furthermore, 100 parts by mass of the urethane prepolymer is mixed and reacted with 3.3 parts by mass of 2-hydroxyethyl acrylate (HEA) at 70° C. for 2 hours with stirring to synthesize an urethane acrylate oligomer (A1-1) having a functionality of 2 and a molecular weight of 7000.

60.0 parts by mass of the urethane acrylate oligomer (A1-1), 40.0 parts by mass of an acrylate monomer manufactured by Kyoei-Sha Chemical Co., Ltd., “LIGHT-ACRYLATE MTG-A” (methoxy triethylene glycol acrylate, functionality=1, molecular weight=218)”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and then the resulting mixture is filtered to obtain a raw UV-curing resin material.

The raw UV-curing resin material is poured into a mold having a cavity of 12.7 mm in depth and 29 mm in inner diameter, capped with a quartz glass plate and then exposed to UV at an irradiation intensity of 700 mW/cm² for 10 seconds to obtain a cylindrical UV-cured resin sample for measuring properties. This sample has an Asker C hardness at a plane part of 54 degrees [measured by an apparatus manufactured by KOBUNSHI KEIKI Co., Ltd.]. Moreover, the compression residual strain of the sample is 3.5% as measured according to JIS K 6262 (1997).

Furthermore, the raw UV-curing resin material is charged between two quartz glass plates through a spacer of 2.0 mm for the preparation of a sheet sample of 2.0 mm. If necessary, the sheet sample can be easily peeled by interposing a PTFE sheet between the UV-cured resin and the quartz glass positioned opposite to the UV-irradiated surface. The thus obtained sample is set in a BOX-type resistance measuring box of JIS, and a resistance thereof is measured at an applied voltage of 100 V by means of a resistance meter manufactured by Advantest, and as a result, the volume resistivity is 8.29×10⁵ Ωcm.

Then, the raw UV-curing resin material is applied onto a conductive roller base material made of polybutylene terephthalate (PBT) resin having an outer diameter of 17.0 mm and inserted with a metal shaft having an outer diameter of 6.0 mm at a thickness of 1500 μm through a die coater, during which the raw UV-curing resin material is cured through spot UV-irradiation. The roller with the thus formed elastic layer made of the UV-cured resin is further irradiated with UV at an irradiation intensity of 700 mW/cm² for 5 seconds while rotating under nitrogen atmosphere.

A raw UV-curing resin material containing microparticles with a hardness higher than that of the elastic layer is applied on the surface of the roller with the elastic layer made of the UV-cured resin through a roll coater and irradiated with UV to obtain a low-hardness UV-cured resin roller having a UV coating on its surface and a roller outer diameter of 20.0 mm. Moreover, the resulting roller has a roller resistance of 1.66×10⁶Ω at 100 V. This roller is incorporated into an electro-photographic apparatus as a developing roller to print pure white, pure black and grayscale images, and as a result, good images can be obtained.

### Example 1-2

100 parts by mass of bifunctional polyoxypropylene glycol having a molecular weight of 3200, 9.2 parts by mass of isophorone diisocyanate (isocyanate index=133) and 0.01 part by mass of dibutyltin dilaurate are reacted at 70° C. for 2 hours with stirring to synthesize an urethane prepolymer having isocyanate groups at both ends of its molecular chain. The resulting urethane prepolymer has a NCO group content of 0.79%. Furthermore, 100 parts by mass of the urethane prepolymer is stirred, mixed and reacted with 2.2 parts by mass of 2-hydroxyethyl acrylate (HEA) at 70° C. for 2 hours to synthesize an urethane acrylate oligomer (A1-2) having a functionality of 2 and a molecular weight of 11000.

60.0 parts by mass of the urethane acrylate oligomer (A1-2), 40.0 parts by mass of an acrylate monomer by Kyoei-Sha Chemical Co., Ltd., “LIGHT-ACRYLATE MTG-A”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material.

A cylindrical UV-cured resin sample for measuring properties is made by using the raw UV-curing resin material in the same manner as in Example 1-1, and then the Asker C hardness and compression residual strain are measured. Also, a sheet sample is made by using the raw UV-curing resin material in the same manner as in Example 1-1, and then the volume resistivity is measured. Further, a roller made of the UV-cured resin is made by using the raw UV-curing resin material in the same manner as in Example 1-1, and then the roller resistance is measured. These results are shown in Table 1-1. Also, the resulting roller is incorporated into an electro-photographic apparatus as a developing roller to print pure white, pure black and grayscale images, and as a result, good images can be obtained.

### Comparative Example 1-1

60.0 parts by mass of a bifunctional urethane acrylate oligomer having a molecular weight of 1300, “UA-4200 [manufactured by Shin-Nakamura Chemical Co., Ltd.]”, 40.0 parts by mass of an acrylate monomer by Kyoei-Sha Chemical Co., Ltd., “LIGHT-ACRYLATE MTG-A”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material.

A cylindrical UV-cured resin sample for measuring properties is made by using the raw UV-curing resin material in the same manner as in Example 1-1, and then the Asker C hardness and compression residual strain are measured. Also, a sheet sample is made by using the raw UV-curing resin material in the same manner as in Example 1-1, and then the volume resistivity is measured. Moreover, a roller made of the UV-cured resin is made by using the raw UV-curing resin material in the same manner as in Example 1-1, and then the roller resistance is measured. These results are shown in Table 1-1. Also, the resulting roller is incorporated into an electro-photographic apparatus as a developing roller to print pure white, pure black and grayscale images, and as a result, an image density is lacking in uniformity and good images cannot be obtained.

### Comparative Example 1-2

60.0 parts by mass of a tetrafunctional urethane acrylate oligomer having a molecular weight of 596, “UA-4HA [manufactured by Shin-Nakamura Chemical Co., Ltd.]”, 40.0 parts by mass of an acrylate monomer by Kyoei-Sha Chemical Co., Ltd., “LIGHT-ACRYLATE MTG-A”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material.

A cylindrical UV-cured resin sample for measuring properties is made by using the raw material for the UV-cured resin in the same manner as in Example 1-1, and then the Asker C hardness and compression residual strain are measured. Also, a sheet sample is made by using the raw UV-curing resin material in the same manner as in Example 1-1, and then the volume resistivity is measured. Moreover, a roller made of the UV-cured resin is made by using the raw UV-curing resin material in the same manner as in Example 1-1, and then the roller resistance is measured. These results are shown in Table 1-2. Also, the resulting roller is incorporated into an electro-photographic apparatus as a developing roller to print pure white, pure black and grayscale images, and as a result, an image density is lacking in uniformity and good images cannot be obtained.

### Comparative Example 1-3

60.0 parts by mass of the urethane acrylate oligomer (A1-1) synthesized in Example 1-1, 40.0 parts by mass of an acrylate monomer by Kyoei-Sha Chemical Co., Ltd., “LIGHT-ACRYLATE MTG-A”, 0.5 part by mass of a photo-polymerization initiator manufactured by Ciba Specialty Chemicals Co., Ltd., “IRGACURE 184D” and 0.8 parts by mass of a conductive carbon manufactured by Ketjen Black International Co., Ltd., “Carbon ECP” are stirred and mixed by an agitator at a liquid temperature of 70° C. and 60 revolutions/minute for 1 hour, and the resulting mixture is filtered to obtain a raw material for a UV-cured resin.

The raw UV-curing resin material is poured into a mold having a cavity of 12.7 mm in depth and 29 mm in inner diameter, capped with a quartz glass plate and then irradiated with UV at an irradiation intensity of 700 mW/cm for 10 seconds, whereby it is attempted to make a cylindrical UV-cured resin sample for measuring properties, but the raw material is not cured and the sample cannot be obtained.

Also, the raw UV-curing resin material is charged between two quartz glass plates through a spacer of 2.0 mm of spacer, whereby it is attempted to make a sheet sample of 2.0 mm, but the raw material is not cured and the sample cannot be obtained.

Furthermore, the raw UV-curing resin material is applied onto a conductive roller base material made of PBT resin having an outer diameter of 17.0 mm and inserted with a metal shaft having an outer diameter of 6.0 mm at a thickness of 1500 μm through a die coater, whereby it is attempted to cure the resin through spot UV-irradiation, but the raw material is not cured and a roller cannot be obtained.

### Comparative Example 1-4

100.0 parts by mass of a polyether polyol, “EXCENOL 840 [manufacture by Asahi Glass Co., Ltd.]”, 0.002 part by mass of dibutyltin dilaurate, and 2.0 parts by mass of an ion conductive agent, “MP-100 [manufactured by Akishima Chemical Industry Co., Ltd.]” are stirred and mixed by an agitator at a liquid temperature of 25° C. and 60 revolutions/minute for 10 minutes to obtain a mixed solution as a liquid A. Also, an isocyanate, “SUMIDUL PF [Sumika Bayer Urethane Co., Ltd.]” is used as a liquid B. 102.002 parts by mass of the liquid A and 8.5 parts by mass of the liquid B are stirred and mixed to obtain a raw urethane resin material.

Immediately after the mixing with stirring, the raw urethane resin material is poured into a mold having a cavity of 12.7 mm in depth and 29 mm in inner diameter, capped with a quartz glass plate, and then cured by heating at 100° C. for 1 hour to make a cylindrical cured urethane resin sample for measuring properties, and then the Asker C hardness and compression residual strain are measured. Also, the raw urethane resin material immediately after the mixing with stirring is poured into a covered aluminum mold having a cavity of 2.0×100×100 mm and cured by heating at 100° C. for 1 hour to make a sheet sample having a thickness of 2.0 mm, and then the volume resistivity is measured. These results are shown in Table 1-2.

Then, a conductive roller base material made of PBT resin having an outer diameter of 17.0 mm and inserted with a metal shaft having an outer diameter of 6.0 mm is set in a pipe-shaped mold having an inner diameter of 20.0 mm through a cap for fixing a metal shaft, and then the raw urethane resin material is poured into the mold under pressure, cured by heating at 100° C. for 1 hour and then taken out from the mold.

A raw UV-curing resin material containing microparticles with a hardness higher than that of the elastic layer is applied onto the surface of the thus obtained roller with the elastic layer made of the urethane resin through a roll coater and irradiated with UV to obtain a low-hardness roller having a UV coating on its surface and a roller outer diameter of 20.0 mm. Moreover, the resulting roller has a roller resistance at 100 V of 1.48×10⁷Ω. This roller is incorporated into an electro-photographic apparatus as a developing roller, and left to stand under NN, LL or HH condition for 2 days, respectively, and thereafter a gray image is printed, and as a result, a good image can be obtained under the NN condition, but an image density is low and a color unevenness is caused under the LL condition, and a stripe-shaped faulty image is caused under the HH condition. Further, traces due to pressure-contacting with a blade are observed on the developing roller.

TABLE 1-1

| | | Example 1-1 | | Example 1-2 | | Comparative Example 1-1 | |
|---|---|---|---|---|---|---|---|
| | | Components and | | Components and | | Components and | |
| | | properties | parts | properties | parts | properties | parts |
| Urethane | Kind | Urethane acrylate oligomer | 60.0 | Urethane acrylate oligomer | 60.0 | UA-4200 | 60.0 |
| acrylate | | (A1-1) | | (A1-2) | | | |
| oligomer | Functionality | 2 | | 2 | | 2 | |
| | Molecular | 7000 | | 11000 | | 1300 | |
| | weight | | | | | | |
| Acrylate | Kind | LIGHT-ACRYLATE | 40.0 | LIGHT-ACRYLATE | 40.0 | LIGHT-ACRYLATE | 40.0 |
| monomer | | MTG-A | | MTG-A | | MTG-A | |
| | Functionality | 1 | | 1 | | 1 | |
| | Molecular | 218 | | 218 | | 218 | |
| | weight | | | | | | |

| | | | | | | |
|---|---|---|---|---|---|---|
| Initiator | IRGACURE 184D | 0.5 | IRGACURE 184D | 0.5 | IRGACURE 184D | 0.5 |
| Conductive agent | MP-100 | 2.0 | MP-100 | 2.0 | MP-100 | 2.0 |

| | | | |
|---|---|---|---|
| Curability | good | good | good |
| Asker C Hardness (degree) | 54 | 48 | 80 |
| Compression residual strain | 3.5 | 4.8 | 1.6 |
| (%) | | | |
| Volume resistivity (Ωcm) | 8.29 × 10⁵ | 1.57 × 10⁶ | 7.45 × 10⁶ |
| Roller resistance (Ω) | 1.66 × 10⁶ | 4.26 × 10⁶ | 6.15 × 10⁶ |
| Evaluation of image | good | good | good |

TABLE 1-2

| | | Comparative | | Comparative | | | | |
|---|---|---|---|---|---|---|---|---|
| | | Example 1-2 | | Example 1-3 | | Comparative | | |
| | | Components and | | Components and | | Example 1-4 | | |
| | | properties | parts | properties | parts | Components | | parts |
| Urethane | Kind | UA-4HA | 60.0 | Urethane acrylate oligomer | 60.0 | Urethane | EXCENOL 840 | 100.0 |
| acrylate | | | | (A1-1) | | resin | (Polyol) | |
| oligomer | Functionality | 4 | | 2 | | | | |
| | Molecular | 596 | | 7000 | | | SUMIDUL PF | 8.5 |
| | weight | | | | | | (Isocynate) | |
| Acrylate | Kind | LIGHT-ACRYLATE | 40.0 | LIGHT-ACRYLATE | 40.0 | | | |
| monomer | | MTG-A | | MTG-A | | | | |
| | Functionality | 1 | | 1 | | | Dibutyltin dilaurate | 0.002 |
| | Molecular | 218 | | 218 | | | (Catalyst) | |
| | weight | | | | | | | |

| | | | | | | |
|---|---|---|---|---|---|---|
| Initiator | IRGACURE 184D | 0.5 | IRGACURE 184D | 0.5 | MP-100 | 2.0 |
| Conductive agent | MP-100 | 2.0 | Carbon ECP | 0.8 | (Conductive agent) | |

| | | | |
|---|---|---|---|
| Curability | good | not cured | good |
| Asker C Hardness (degree) | 92 | incapable of measuring | 45 |
| Compression residual strain | incapable of measuring | incapable of measuring | 8.1 |
| (%) | | | |
| Volume resistivity (Ωcm) | 8.80 × 10⁶ | incapable of measuring | 5.25 × 10⁷ |
| Roller resistance (Ω) | 2.57 × 10⁶ | incapable of measuring | 1.48 × 10⁷ |
| Evaluation of image | bad | incapable of measuring | bad |

UA-4200: bifunctional urethane acrylate oligomer having a molecular weight of 1300, manufactured by Shin-Nakamura Chemical Co., Ltd.
UA-4HA: tetrafunctional urethane acrylate oligomer having a molecular weight of 596, manufactured by Shin-Nakamura Chemical Co., Ltd.
LIGHT-ACRYLATE MTG-A: methoxy triethylene glycol acrylate, functionality = 1, molecular weight = 218, manufactured by Kyoei-Sha Chemical Co., Ltd.
IRGACURE 184D: a photo-polymerization initiator, manufactured by Ciba Specialty Chemicals Co., Ltd.
MP-100: an ion conductive agent, manufactured by Akishima Chemical Industry Co., Ltd.
EXCENOL 840: a polyether polyol, manufacture by Asahi Glass Co., Ltd.
SUMIDUL PF: an isocyanate, Sumika Bayer Urethane Co., Ltd.

As seen from Examples 1-1 and 1-2, the conductive elastic roller provided with the elastic layer composed of an ultraviolet-curing type resin formed by curing a raw material for the elastic layer comprising an urethane acrylate oligomer (A1) having a functionality of 1.0-3.0 and a molecular weight of 5,000-100,000, a photo-polymerization initiator (B) and a conductive agent (C) by ultraviolet irradiation is low in the hardness and small in the compression residual strain.

On the other hand, as seen from Comparative Example 1-1, the hardness of the elastic layer becomes significantly high when using the urethane acrylate oligomer having a molecular weight of less than 5,000. Also, as seen from Comparative Example 1-2, the hardness of the elastic layer becomes significantly high when using the urethane acrylate oligomer having a functionality of more than 3.0. Furthermore, as seen from Comparative Example 1-3, when an opaque carbon-based electron conductive agent is used, the ultraviolet-curing type resin cannot be formed. Moreover, as seen from Comparative Example 1-4, the roller comprising the elastic layer made of an urethane resin is large in the compression residual strain.

<Second Conductive Elastic Roller>

### Example 2-1

80.0 parts by mass of an urethane acrylate oligomer, “UA-340P [manufactured by Shin-Nakamura Chemical Co., Ltd.]”, 20.0 parts by mass of an acrylate monomer manufactured by Kyoei-Sha Chemical Co., Ltd., “LIGHT-ACRYLATE MTG-A”, 0.5 part by mass of a photo-polymerization initiator manufactured by Ciba Specialty Chemicals Co., Ltd., “IRGACURE 184D” and 2.0 parts by mass of an ion conductive agent manufactured by Sanko Chemical Co., Ltd., “Sankonol (registered trademark) PEO-20R (a mixture of 80% by mass of polyalkyleneoxide polyol and 20% by mass of Li(CF₃SO₂)₂N)” are stirred and mixed by an agitator at a liquid temperature of 70° C. and 60 revolutions/minute for 1 hour, and the resulting mixture is filtered to obtain a raw UV-curing resin material.

The raw UV-curing resin material is charged between two quartz glass plates through a spacer of 2.0 mm of spacer for the preparation of a sheet sample of 20 mm. If necessary, the sheet sample can be easily peeled by interposing a PTFE sheet between the UN-cured resin and the quartz glass positioned opposite to the UV-irradiated surface. The sample thus obtained is left to stand at 20° C. and 50% RH (NN condition) for 2 days, and then set in a BOX-type resistance measuring box of JIS, and the resistance is measured at an applied voltage of 100 V by means of a resistance meter manufactured by Advantest, and as a result, the volume resistivity is 1.31×10⁷ Ωcm (10^{7.12} Ωcm). Similarly, it is left to stand at 12° C. and 10% RH (LL condition) for 2 days, and then the resistance is measured, and as a result, the volume resistivity is 3.99×10⁷ Ωcm (10^{7.60} Ωcm). Further, the resistance is measured after being left to stand at 32.5° C. and 85% RH (HH condition) for 2 days, and as a result, the volume resistivity is 3.27×10⁶ Ωcm (10^{6.51} Ωcm). From logarithmic values, a difference of the volume resistivity between LL and HH conditions is 1.09 power.

Then, the raw UV-curing resin material is applied onto a conductive roller base material made of polybutylene terephthalate (PBT) resin having an outer diameter of 17.0 mm and inserted with a metal shaft having an outer diameter of 6.0 mm at a thickness of 1500 μm through a die coater, during which the raw resin material is cured through spot UV-irradiation. The roller with the thus formed elastic layer made of the UV-cured resin is further irradiated with UV at an irradiation intensity of 700 mW/cm² for 5 seconds while rotating under nitrogen atmosphere.

A raw UV-curing resin material containing microparticles with a hardness higher than that of the elastic layer is applied onto the surface of the thus obtained roller with the elastic layer made of the UV-cured resin through a roll coater and irradiated with UV to obtain a low-hardness UV-cured resin roller having a UV coating on its surface and a roller outer diameter of 20.0 mm. This roller is incorporated into an electro-photographic apparatus as a developing roller and left to stand under NN, LL or HH condition for 2 days, respectively, and thereafter a gray image is printed, and as a result, good images can be obtained under each condition.

### Example 2-2

A raw UV-curing resin material having a compounding recipe shown in Table 2-1 is prepared, and then a sheet sample is made in the same manner as in Example 2-1. The volume resistivity after being left to stand under NN, LL or HH condition for 2 days is measured, and a difference of the volume resistivity between LL and HH conditions is determined. These results are shown in Table 2-1. Then, a roller made of a UV resin is prepared by using the raw UV-curing resin material in the same manner as in Example 2-1. The roller is incorporated into an electro-photographic apparatus as a developing roller and left to stand under NN, LL or HH condition for 2 days, respectively, and thereafter pure white, pure black and grayscale images are printed, and as a result, good images can be obtained under each condition.

### Comparative Example 2-1

A raw UV-curing resin material having a compounding recipe shown in Table 2-1 is prepared, and then a sheet sample is made in the same manner as in Example 2-1. The volume resistivity after being left to stand under NN, LL or HH condition for 2 days is measured, and a difference of the volume resistivity between LL and HH conditions is determined. These results are shown in Table 2-1. Then, a roller made of a UV resin is made by using the raw UV-curing resin material in the same manner as in Example 2-1. The roller is incorporated into an electro-photographic apparatus as a developing roller and left to stand under NN, LL or HH condition for 2 days, respectively, and thereafter a gray image is printed, and as a result, good images can be obtained under the NN and LL conditions, but an image density is low and a color unevenness is caused under the HH condition.

### Comparative Example 2-2

A raw UV-curing resin material having a compounding recipe shown in Table 2-2 is prepared, and then a sheet sample is made in the same manner as in Example 2-1. The volume resistivity after being left to stand under NN, LL or HH condition for 2 days is measured, and a difference of the volume resistivity between LL and HH conditions is determined. These results are shown in Table 2-2. Then, a roller made of a UV resin is made by using the raw UV-curing resin material in the same manner as in Example 2-1. The roller is incorporated into an electro-photographic apparatus as a developing roller and left to stand under NN, LL or HH condition for 2 days, respectively, and thereafter a gray image is printed, and as a result, good images can be obtained under the NN and HH conditions, but an image density is low and a color unevenness is caused under the LL condition.

### Comparative Example 2-3

100.0 parts by mass of a polyether polyol, “EXCENOL 851 [manufacture by Asahi Glass Co., Ltd.]”, 0.002 part by mass of dibutyltin dilaurate, and 2.8 parts by mass of an ion conductive agent, “MP-100 [manufactured by Akishima Chemical Industry Co., Ltd.]” are stirred and mixed by an agitator at a liquid temperature of 25° C. and 60 revolutions/minute for 10 minutes to obtain a mixed solution as a liquid A. Also, an isocyanate, “SUMIDUL PF [Sumika Bayer Urethane Co., Ltd.]” is used as a liquid B. 102.802 parts by mass of the liquid A and 8.5 parts by mass of the liquid B are mixed with stirring to obtain a raw urethane resin material.

Immediately after the mixing with stirring, the raw urethane material is poured into a covered aluminum mold having a cavity of 2.0×100×100 mm and cured by heating at 100° C. for 1 hour to make a sheet sample having a thickness of 2.0 mm. With respect to this sample, the resistivity after being left to stand under NN, LL or HH condition for 2 days is measured, and a difference of the volume resistivity between LL and HH conditions is determined. These results are shown in Table 2-2.

Then, a conductive roller base material made of PBT resin having an outer diameter of 17.0 mm and inserted with a metal shaft having an outer diameter of 6.0 mm is set in a pipe-shaped mold having an inner diameter of 20.0 mm through a cap for fixing a metal shaft, and the raw urethane resin material is poured thereinto under pressure, cured by heating at 100° C. for 1 hour and then taken out from the mold.

A raw UV-curing resin material containing microparticles with a hardness higher than that of the elastic layer is applied onto the surface of the thus obtained roller with the elastic layer made of the urethane resin through a roll coater and irradiated with UV to obtain a low-hardness roller having a UV coating on its surface and a roller outer diameter of 20.0 mm. This roller is incorporated into an electro-photographic apparatus as a developing roller and left to stand under NN, LL or HH condition for 2 days, respectively, and thereafter gray image is printed, and as a result, good images can be obtained under the NN and HH conditions, but an image density is low and a color unevenness is caused under the LL condition.

### Comparative Examples 2-4

100.0 parts by mass of a polyether polyol, “EXCENOL 851 [manufacture by Asahi Glass Co., Ltd.]”, 0.002 part by mass of dibutyltin dilaurate, and 2.8 parts by mass of an ion conductive agent, “KS555 [manufactured by Kao Corporation]” are stirred and mixed by an agitator at a liquid temperature of 25° C. and 60 revolutions/minute for 10 minutes to obtain a mixed solution as a liquid A. Also, an isocyanate, “SUMIDUL PF [Sumika Bayer Urethane Co., Ltd.]” is used as a liquid B. 102.802 parts by mass of the liquid A and 8.5 parts by mass of the liquid B are mixed with stirring to obtain a raw urethane resin material. A sheet sample is made by using the raw urethane resin material in the same manner as in Comparative Example 2-3, and then the volume resistivity after being left to stand under NN, LL or HH condition for 2 days is measured, and a difference of the volume resistivity between LL and HH conditions is determined. These results are shown in Table 2-2. Then, a roller is made by using the raw urethane resin material in the same manner as in Comparative Example 2-3. The roller is incorporated into an electro-photographic apparatus as a developing roller and left to stand under NN, LL or HH condition for 2 days, respectively, and then a gray image is printed, and as a result, a good image can be obtained under the HH condition, but an image density is low and a color unevenness is caused under the NN or LL condition.

TABLE 2-1

| | | | | | | Comparative | |
|---|---|---|---|---|---|---|---|
| | | Example 2-1 | | Example 2-2 | | Example 2-1 | |
| | | Components and | | Components and | | Components and | |
| | | properties | parts | properties | parts | properties | parts |
| Urethane | Kind | UA-340P | 80.0 | UA-340P | 80.0 | UA-340P | 80.0 |
| acrylate | | | | | | | |
| oligomer | | | | | | | |
| Acrylate | Kind | LIGHT-ACRYLATE | 20.0 | LIGHT-ACRYLATE | 20.0 | LIGHT-ACRYLATE | 20.0 |
| monomer | | MTG-A | | MTG-A | | MTG-A | |
| | Functionality | 1 | | 1 | | 1 | |
| | Molecular | 218 | | 218 | | 218 | |
| | weight | | | | | | |

| | | | | | | |
|---|---|---|---|---|---|---|
| Initiator | IRGACURE 184D | 0.5 | IRGACURE 184D | 0.5 | IRGACURE 184D | 0.5 |
| Ion conductive agent | PEO-20R | 2.0 | PETA-20R | 2.0 | MP-100 | 2.6 |

| | | | | |
|---|---|---|---|---|
| Volume | L/L | 10^{7.60} Ωcm | 10^{7.61} Ωcm | 10^{7.50} Ωcm |
| resistivity | N/N | 10^{7.12} Ωcm | 10^{7.13} Ωcm | 10^{6.47} Ωcm |
| | H/H | 10^{6.51} Ωcm | 10^{6.55} Ωcm | 10^{5.86} Ωcm |
| | L/L − H/H | 1.09 power | 1.06 power | 1.64 power |
| Evaluation | L/L | good | good | good |
| of image | N/N | good | good | good |
| | H/H | good | good | bad |

TABLE 2-2

| | | Comparative | | | | | | | |
|---|---|---|---|---|---|---|---|---|---|
| | | Example 2-2 | | Comparative | | | Comparative | | |
| | | Components and | | Example 2-3 | | | Example 2-4 | | |
| | | properties | parts | Components | | parts | Components | | parts |
| Urethane | Kind | UA-340P | 80.0 | Urethane | EXCENOL 851 | 100.0 | Urethane | EXCENOL 851 | 100.0 |
| acrylate | | | | resin | (Polyol) | | resin | (Polyol) | |
| oligomer | | | | | SUMIDUL PF | 8.5 | | SUMIDUL PF | 8.5 |
| Acrylate | Kind | LIGHT-ACRYLATE | 20.0 | | (Isocynate) | | | (Isocynate) | |
| monomer | | MTG-A | | | | | | | |
| | Functionality | 1 | | | Dibutyltin dilaurate | 0.002 | | Dibutyltin dilaurate | 0.002 |
| | Molecular | 218 | | | (Catalyst) | | | (Catalyst) | |
| | weight | | | | | | | | |

| | | | | | | |
|---|---|---|---|---|---|---|
| Initiator | IRGACURE 184D | 0.5 | MP-100 | 2.8 | KS555 | 2.8 |
| Conductive agent | KS555 | 2.6 | (Ion conductive agent) | | (Ion conductive agent) | |

| | | | | |
|---|---|---|---|---|
| Volume | L/L | 10^{8.27} Ωcm | 10^{8.46} Ωcm | 10^{9.26} Ωcm |
| resistivity | N/N | 10^{7.33} Ωcm | 10^{7.45} Ωcm | 10^{8.31} Ωcm |
| | H/H | 10^{6.30} Ωcm | 10^{6.70} Ωcm | 10^{7.27} Ωcm |
| | L/L − H/H | 1.97 power | 1.76 power | 1.99 power |
| Evaluation | L/L | bad | bad | bad |
| of image | N/N | good | good | bad |
| | H/H | good | good | good |

UA-340P: an urethane acrylate oligomer, manufactured by Shin-Nakamura Chemical Co., Ltd.
LIGHT-ACRYLATE MTG-A: an acrylate monomer, manufactured by Kyoei-Sha Chemical Co., Ltd.
IRGACURE 184D: a photo-polymerization initiator, manufactured by Ciba Specialty Chemicals Co., Ltd.
PEO-20R: an ion conductive agent, “Sankonol (registered trademark) PEO-20R (a mixture of 80% by mass of polyalkyleneoxide polyol and 20% by mass of Li(CF₃SO₂)₂N)”, manufactured by Sanko Chemical Co., Ltd.
PETA-20R: an ion conductive agent, “Sankonol (registered trademark) PETA-20R (a mixture of 80% by mass of pentaerythritol triacrylate and 20% by mass of Li(CF₃SO₂)₂N)”, manufactured by Sanko Chemical Co., Ltd.
MP-100: an ion conductive agent, “MP-100 (a mixture of 60-80% of sodium perchlorate polyol complex salt and 20-40% of polyol)”, manufactured by Akishima Chemical Industry Co., Ltd.
KS555: an ion conductive agent, “KS555 (quaternary ammonium salt•perchlorate, RNCH₃(CH₂CH₂OH)₂•ClO₄)”, manufactured by Kao Corporation
EXCENOL 851: a polyether polyol, manufacture by Asahi Glass Co., Ltd.
SUMIDUL PF: an isocyanate, Sumika Bayer Urethane Co., Ltd.

As seen from Examples 2-1 and 2-2, the conductive elastic roller provided with the elastic layer composed of an ultraviolet-curing type resin formed by curing a raw material for the elastic layer comprising an urethane acrylate oligomer (A) and a photo-polymerization initiator (B) and further comprising a lithium salt (C1) as an ion conductive agent through ultraviolet irradiation is small in the environment dependence of the volume resistivity of the elastic layer.

On the other hand, as seen from the results of Comparative Examples 1-4, when the ion conductive agent except the lithium salt (C1) is used, the environment dependence of the volume resistivity of the elastic layer is significantly high.

<Third Conductive Elastic Roller>

### Example 3-1

70.0 parts by mass of an urethane acrylate oligomer, “UA-334PZ [manufactured by Shin-Nakamura Chemical Co., Ltd.]”, 30.0 parts by mass of an acrylate monomer, “LIGHT-ACRYLATE IM-A [isomyristyl acrylate (CH₂═CHCOOC₁₄H₂₉), manufactured by Kyoei-Sha Chemical Co., Ltd.]”, 0.5 part by mass of a photo-polymerization initiator, “IRGACURE 184D [manufactured by Ciba Specialty Chemicals Co., Ltd.]” and 2.0 parts by mass of an ion conductive agent, “MP-100 [manufactured by Akishima Chemical Industry Co., Ltd.]” are stirred and mixed by an agitator at a liquid temperature of 70° C. and 60 revolutions/minute for 1 hour, and the resulting mixture is filtered to obtain a raw UV-curing resin material.

The raw UV-curing resin material is poured into a mold having a cavity of 12.7 mm in depth and 29 mm in inner diameter, capped with a quartz glass plate and then irradiated with UV at an irradiation intensity of 700 mW/cm² for 10 seconds to obtain a cylindrical UV-cured resin sample for measuring properties. This sample has an Asker C hardness at a plane part of 45 degrees [measured by an apparatus manufactured by KOBUNSHI KEIKI Co., Ltd.].

Also, the raw UV-curing resin material is charged between two quartz glass plates through a space of 2.0 mm for the preparation of a sheet sample of 2.0 mm. If necessary, the sheet sample can be easily peeled by interposing a PTFE sheet between the UV-cured resin and the quartz glass positioned opposite to the UV-irradiated surface. As the dimensional change of the sample due to environmental conditions is measured, a dimensional change (B-A) between a thickness (A) after being left to stand under environmental conditions of 12° C. and 10% RH (LL condition) for 2 days and a thickness (B) after being left to stand under environmental conditions of 32.5° C. and 85% RH (HH condition) for 2 days is 30 μm.

Then, the raw UV-curing resin material is applied onto a conductive roller base material made of polybutylene terephthalate (PBT) resin having an outer diameter of 17.0 mm and inserted with a metal shaft having an outer diameter of 6.0 mm at a thickness of 1500 μm through a die coater, during which the raw UV-curing resin material is cured through spot UV-irradiation. The roller with the thus formed elastic layer made of the UV-cured resin is further irradiated with UV at an irradiation intensity of 700 mW/cm for 5 seconds while rotating under nitrogen atmosphere.

A raw UV-curing resin material containing microparticles having a higher hardness than the elastic layer is applied onto the surface of the thus obtained roller with the elastic layer made of the UV-cured resin through a roll coater and irradiated with UV to obtain a low-hardness UV-cured resin roller having a UV coating on its surface and a roller outer diameter of 20.0 mm. As the dimensional change of the roller due to environmental conditions is measured, the dimensional change (D-C) between an outer diameter (C) after being left to stand under environmental conditions of 12° C. and 10% RH (LL condition) for 2 days and an outer diameter (D) after being left to stand under environmental conditions of 32.5° C. and 85% RH (HH condition) for 2 days is 57 μm.

Furthermore, another roller made according to the above description is incorporated into an electro-photographic apparatus as a developing roller and left to stand at 20° C. and 50% RH (NN condition), 12° C. and 10% RH (LL condition) or 32.5° C. and 85% RH (HH condition) for 2 days, respectively, and then a gray image is printed, and as a result, good images can be obtained under every condition.

### Example 3-2

A raw UV-curing resin material having a compounding recipe shown in Table 3-1 is prepared, and a cylindrical UV-cured resin sample for measuring properties is made in the same manner as in Example 3-1, and then the Asker C hardness is measured. Also, a sheet sample is made by using the raw UV-curing resin material in the same manner as in Example 3-1, and then the dimensional change due to environmental conditions is measured. Then, a roller made of a UV resin is made by using the raw UV-curing resin material in the same manner as in Example 3-1, and then the dimensional change due to environmental conditions is measured. These results are shown in Table 3-1. Further, anther roller made in the same manner as mentioned above is incorporated into an electro-photographic apparatus as a developing roller and left to stand under NN, LL or HH condition for 2 days, respectively, and then a gray image is printed, and as a result, good images can be obtained under every condition.

### Example 3-3

A raw UV-curing resin material having a compounding recipe shown in Table 3-1 is prepared, and then a cylindrical UV-cured resin sample for measuring properties is made in the same manner as in Example 3-1, and the Asker C hardness is measured. Also, a sheet sample is made by using the raw UV-curing resin material in the same manner as in Example 3-1, and then the dimensional change due to environmental conditions is measured. Then, a roller made of a UV resin is made by using the raw UV-cured resin material in the same manner as in Example 3-1, and then the dimensional change due to environmental conditions is measured. These results are shown in Table 3-1. Moreover, anther roller made in the same manner as mentioned above is incorporated into an electro-photographic apparatus as a developing roller and left to stand under NN, LL or HH condition for 2 days, respectively, and then a gray image is printed, and as a result, good images can be obtained under every condition.

### Example 3-4

A raw UV-curing resin material having a compounding recipe shown in Table 3-2 is prepared, and then the cylindrical UV-cured resin sample for measuring properties is made in the same manner as in Example 3-1, and the Asker C hardness is measured. Also, a sheet sample is made by using the raw UV-cured resin material in the same manner as in Example 3-1, and then the dimensional change due to environmental conditions is measured. Then, a roller made of a UV resin is made by using the raw UV-cured resin material in the same manner as in Example 3-1, and then the dimensional change due to environmental conditions is measured. These results are shown in Table 3-2. Moreover, anther roller made in the same manner as mentioned above is incorporated into an electro-photographic apparatus as a developing roller and left to stand under NN, LL or HH condition for 2 days, respectively, and then a gray image is printed, and as a result, good images can be obtained under every condition.

### Comparative Example 3-1

A raw UV-curing resin material having a compounding recipe shown in Table 3-2 is prepared, and then a cylindrical UV-cured resin sample for measuring properties is made in the same manner as in Example 3-1, and the Asker C hardness is measured. Also, a sheet sample is made by using the raw UV-curing resin material in the same manner as in Example 3-1, and then the dimensional change due to environmental conditions is measured. Then, a roller made of a UV resin is made by using the raw UV-curing resin material in the same manner as in Example 3-1, and then the dimensional change due to environmental conditions is measured. These results are shown in Table 3-2. Moreover, anther roller made in the same manner as mentioned above is incorporated into an electro-photographic apparatus as a developing roller and left to stand under NN, LL or HH condition for 2 days, respectively, and then a gray image is printed, and as a result, good images can be obtained under the NN and LL conditions, but a stripe-shaped faulty image is caused under the HH condition. Also, traces due to pressure-contacting with a developing blade are observed on the surface of the developing roller.

### Comparative Example 3-2

A raw UV-curing resin material having a compounding recipe shown in Table 3-2 is prepared, and then a cylindrical UV-cured resin sample for measuring properties is made in the same manner as in Example 3-1, and the Asker C hardness is measured. Also, a sheet sample is made by using the raw UV-curing resin material in the same manner as in Example 3-1, and then the dimensional change due to environmental conditions is measured. Then, a roller made of a UV resin is made by using the raw UV-curing resin material in the same manner as in Example 3-1, and then the dimensional change due to environmental conditions is measured. These results are shown in Table 3-2. Moreover, anther roller made in the same manner as mentioned above is incorporated into an electro-photographic apparatus as a developing roller and left to stand under NN, LL or HH condition for 2 days, respectively, and then a gray image is printed, and as a result, good images can be obtained under the NN and LL conditions, but a line-shaped faulty image is caused under the HH condition. Also, traces due to pressure-contacting with a developing blade are observed on the surface of the developing roller.

TABLE 3-1

| | Example 3-1 | | Example 3-2 | | Example 3-3 | |
|---|---|---|---|---|---|---|
| | Components | parts | Components | parts | Components | parts |
| Urethane acrylate | UA-334PZ | 70.0 | UA-334PZ | 60.0 | UA-334PZ | 70.0 |
| oligomer | | | | | | |
| Acrylate monomer | LIGHT-ACRYLATE IM-A | 30.0 | LIGHT-ACRYLATE IM-A | 40.0 | LIGHT-ACRYLATE L-A | 30.0 |
| Initiator | IRGACURE 184D | 0.5 | IRGACURE 184D | 0.5 | IRGACURE 184D | 0.5 |
| Conductive agent | MP-100 | 2.0 | MP-100 | 2.0 | MP-100 | 2.0 |

| Asker C Hardness | | 45 | 40 | 36 |
|---|---|---|---|---|
| (degree) | | | | |
| Dimensional | | 30 | 26 | 33 |
| change of | | | | |
| sheet (μm) | | | | |
| Outer diameter | | 57 | 53 | 59 |
| change of | | | | |
| roller (μm) | | | | |
| Evaluation | L/L | good | good | good |
| of image | N/N | good | good | good |
| | H/H | good | good | good |

TABLE 3-2

| | | | Comparative | | Comparative | |
|---|---|---|---|---|---|---|
| | Example 3-4 | | Example 3-1 | | Example 3-2 | |
| | Components | parts | Components | parts | Components | parts |
| Urethane acrylate | UA-334PZ | 70.0 | UA-334PZ | 70.0 | UA-334PZ | 60.0 |
| oligomer | | | | | | |
| Acrylate monomer | LIGHT-ACRYLATE IM-A | 15.0 | LIGHT-ACRYLATE | 30.0 | LIGHT-ACRYLATE | 40.0 |
| | LIGHT-ACRYLATE S-A | 15.0 | MTG-A | | MTG-A | |
| Initiator | IRGACURE 184D | 0.5 | IRGACURE 184D | 0.5 | IRGACURE 184D | 0.5 |
| Conductive agent | MP-100 | 2.0 | MP-100 | 2.0 | MP-100 | 2.0 |

| Asker C Hardness | | 48 | 45 | 42 |
|---|---|---|---|---|
| (degree) | | | | |
| Dimensional | | 29 | 41 | 48 |
| change of | | | | |
| sheet (μm) | | | | |
| Outer diameter | | 56 | 78 | 82 |
| change of | | | | |
| roller (μm) | | | | |
| Evaluation | L/L | good | good | good |
| of image | N/N | good | good | good |
| | H/H | good | bad | bad |

UA-334PZ: an urethane acrylate oligomer, manufactured by Shin-Nakamura Chemical Co., Ltd.
LIGHT-ACRYLATE IM-A: an acrylate monomer, isomyristyl acrylate (CH₂═CHCOOC₁₄H₂₉), manufactured by Kyoei-Sha Chemical Co., Ltd.
LIGHT-ACRYLATE L-A: an acrylate monomer, lauryl acrylate (CH₂═CHCOOC₁₂H₂₅), manufactured by Kyoei-Sha Chemical Co., Ltd.
LIGHT-ACRYLATE S-A: an acrylate monomer, stearyl acrylate (CH₂═CHCOOC₁₈H₃₇), manufactured by Kyoei-Sha Chemical Co., Ltd.
LIGHT-ACRYLATE MTG-A: an acrylate monomer, methoxy-triethylene glycol acrylate {CH₂═CHCOO—(CH₂CH₂O)₃—CH₃}, manufactured by Kyoei-Sha Chemical Co., Ltd.
IRGACURE 184D: a photo-polymerization initiator, manufactured by Ciba Specialty Chemicals Co., Ltd.
MP-100: an ion conductive agent, manufactured by Akishima Chemical Industry Co., Ltd.

As seen from Examples 3-1 to 3-4, the conductive elastic roller provided with the elastic layer composed of an ultraviolet-curing type resin formed by curing a raw material for the elastic layer comprising an urethane acrylate oligomer (A), a photo-polymerization initiator (B) and a conductive agent (C) and further comprising an acrylate monomer (D1) represented by the general formula (I) through ultraviolet irradiation is small in the environment dependence of the dimension of the elastic layer and good images can be formed under any one of NN, LL and HH conditions.

On the other hand, as seen from the results of Comparative Examples 3-1 and 3-2, when an acrylate monomer (D2) except the acrylate monomer (D1) represented by the formula (I) is used, the environment dependence of the dimension of the elastic layer is significantly high and a faulty image is caused under the HH condition.

<Fourth Conductive Elastic Roller>

### Example 4-1

70.0 parts by mass of an urethane acrylate oligomer, “UA-334PZ [manufactured by Shin-Nakamura Chemical Co., Ltd.]”, 20.0 parts by mass of an acrylate monomer, “LIGHT-ACRYLATE MTG-A [methoxy triethylene glycol acrylate, functionality=1, molecular weight=218, manufactured by Kyoei-Sha Chemical Co., Ltd.]”, 10 parts by mass of a partial ester, “NK ESTER A-SA [β-acryloyloxyethyl hydrogen succinate (CH₂═CHCOOCH₂CH₂OCOCH₂CH₂COOH), manufactured by Shin-Nakamura Chemical Co., Ltd.]”, 0.5 part by mass of a photo-polymerization initiator, “IRGACURE 184D [manufactured by Ciba Specialty Chemicals Co., Ltd.]” and 2.0 parts by mass of an ion conductive agent, “MP-100 [manufactured by Akishima Chemical Industry Co., Ltd.]” are stirred and mixed by an agitator at a liquid temperature of 70° C. and 60 revolutions/minute for 1 hour, and the resulting mixture is filtered to obtain a raw UV-curing resin material.

The raw UV-curing resin material is poured into a mold having a cavity of 12.7 mm in depth and 29 mm in inner diameter, capped with a quartz glass plate and then irradiated with UV at an irradiation intensity of 700 mW/cm for 10 seconds to obtain a cylindrical UV-cured resin sample for measuring properties. This sample has an Asker C hardness at a plane part of 47 degrees [measured by an apparatus manufactured by KOBUNSHI KEIKI Co., Ltd.]. Also, this sample has a compression residual strain of 3.6% as measured according to JIS K 6262 (1997).

Further, the raw UV-curing resin material is charged between two quartz glass plates through a spacer of 2.0 mm for the preparation of a sheet sample of 2.0 mm. If necessary, the sheet sample can be easily peeled by interposing a PTFE sheet between the UV-cured resin and the quartz glass positioned opposite to the UV-irradiated surface. The sample thus obtained is set in a BOX-type resistance measuring box of JIS, and then the resistance is measured at an applied voltage of 100 V by means of a resistance meter manufactured by Advantest, and as a result, the volume resistivity is 8.50×10⁶ Ωcm.

Then, the raw UV-curing resin material is applied onto a conductive roller base material made of polybutylene terephthalate (PBT) resin having an outer diameter of 17.0 mm and inserted with a metal shaft having an outer diameter of 6.0 mm at a thickness of 1500 μm through a die coater, during which the raw UV-curing resin material is cured through spot UV-irradiation. The roller with the thus formed elastic layer made of the UV-cured resin is further irradiated with UV at an irradiation intensity of 700 mW/cm² for 5 seconds while rotating under nitrogen atmosphere.

A raw UV-curing resin material comprising 60 parts by mass of an urethane acrylate oligomer, “UV3000B [manufactured by Nippon Synthetic Chemical Industry Co., Ltd.]”, 40 parts by mass of morpholine acrylate, “A-MO [manufactured by Shin-Nakamura Chemical Co., Ltd., functionality=1]” and 1 part by mass of a photo-polymerization initiator, “IRGACURE 184D [manufactured by Ciba Specialty Chemicals Co., Ltd.]” is applied onto the surface of the thus obtained roller with the elastic layer made of the UV-cured resin through a roll coater and irradiated with UV to obtain a low-hardness UV resin roller having a UV coating [thickness: 10 μm] on its surface and a roller outer diameter of 20.0 mm.

The adhesion property between the elastic layer and the coating layer of the resulting roller is tested according to a cross cut test of JIS method (JIS K 5600-5-6:1999). Concretely, 5 pieces of grids are respectively cut lengthwise and breadthwise, i.e., 25 pieces of grids are cut by a razor [manufactured by Gillette] and attached with a cellophane tape, and thereafter the cellophane tape is peeled at once. The grids not peeling by the cellophane tape are counted, and as a result, all of 25 pieces are not peeled from the roller.

Further, another roller made according to the above description is incorporated into an electro-photographic apparatus as a developing roller and left to stand under NN condition (20° C., 50% RH) for 2 days and an endurance test is conducted for gray color, and as a result, a peeling of the coating layer is not observed even after 12000 sheets were printed and good images can be obtained. Furthermore, another roller made according to the above description is incorporated into an electro-photographic apparatus as a developing roller and left to stand under HH condition (32.5° C., 85% RH) for 2 days and an image evaluation is conducted for gray color, and as a result, good images can be obtained.

### Example 4-2

A raw UV-curing resin material for an elastic layer having a compounding recipe shown in Table 4-1 is prepared, and then a cylindrical UV-cured resin sample for measuring properties is made in the same manner as in Example 4-1, and the Asker C hardness and compression residual strain are measured. Also, a sheet sample is made from the raw UV-curing resin material for the elastic layer in the same manner as in Example 4-1, and then the volume resistivity is measured. Then, a roller made of a UV resin is made by using a raw UV-curing resin material for an elastic layer and a raw UV-curing resin material for a coating layer having a compounding recipe as shown in Table 4-1 in the same manner as in Example 4-1, and then the adhesion property between the elastic layer and the coating layer of the resulting roller is evaluated. These results are shown in Table 4-1. Moreover, anther roller made in the same manner as mentioned above is incorporated into an electro-photographic apparatus as a developing roller and left to stand under NN condition for 2 days and an endurance test is conducted for gray color, and as a result, the peeling of the coating layer is not observed even after 12000 sheets were printed and good images can be obtained. Furthermore, another roller made in the same manner is incorporated into an electro-photographic apparatus as a developing roller and left to stand under HH condition for 2 days and an image evaluation is conducted for gray color, and as a result, good images can be obtained.

### Example 4-3

A raw UV-curing resin material for an elastic layer having a compounding recipe shown in Table 4-1 is prepared, and then a cylindrical UV-cured resin sample for measuring properties is made in the same manner as in Example 4-1, and the Asker C hardness and compression residual strain are measured. Also, a sheet sample is made from the raw UV-curing resin material for the elastic layer in the same manner as in Example 4-1, and then the volume resistivity is measured. Then, a roller made of a UV resin is made by using a raw UV-cured resin material for an elastic layer and a raw UV-curing resin material for a coating layer having a compounding recipe as shown in Table 4-1 in the same manner as in Example 4-1, and then the adhesion property between the elastic layer and the coating layer of the resulting roller is evaluated. These results are shown in Table 4-1. Moreover, anther roller made in the same manner as mentioned above is incorporated into an electro-photographic apparatus as a developing roller and left to stand under NN condition for 2 days and an endurance test is conducted for gray color, and as a result, the peeling of the coating layer is not observed even after 12000 sheets were printed and good images can be obtained. Furthermore, another roller made in the same manner as mentioned above is incorporated into an electro-photographic apparatus as a developing roller and left to stand under HH condition for 2 days and an image evaluation is conducted for gray color, and as a result, good images can be obtained.

### Example 4-4

A raw UV-curing resin material for an elastic layer having a compounding recipe shown in Table 4-1 is prepared, and then a cylindrical UV-cured resin sample for measuring properties is made in the same manner as in Example 4-1, and the Asker C hardness and compression residual strain are measured. Also, a sheet sample is made from the raw UV-curing resin material for the elastic layer in the same manner as in Example 4-1, and then the volume resistivity is measured. Then, a roller made of a UV resin is made by using a raw UV-curing resin material for an elastic layer and a raw UV-curing resin material for a coating layer having a compounding recipe as shown in Table 4-1 in the same manner as in Example 4-1, and then the adhesion property between the elastic layer and the coating layer of the resulting roller is evaluated. These results are shown in Table 4-1. Moreover, anther roller made in the same manner as mentioned above is incorporated into an electro-photographic apparatus as a developing roller and left to stand under NN condition for 2 days and an endurance test is conducted for gray color, and as a result, the peeling of the coating layer is not observed even after 12000 sheets were printed and good images can be obtained. Furthermore, another roller made in the same manner as mentioned above is incorporated into an electro-photographic apparatus as a developing roller and left to stand under HH condition for 2 days and an image evaluation is conducted for gray color, and as a result, good images can be obtained.

### Example 4-5

A raw UV-curing resin material for an elastic layer having a compounding recipe shown in Table 4-1 is prepared, and then a cylindrical UV-cured resin sample for measuring properties is made in the same manner as in Example 4-1, and the Asker C hardness and compression residual strain are measured. Also, a sheet sample is made from the raw UV-curing resin material for the elastic layer in the same manner as in Example 4-1, and then the volume resistivity is measured. Then, a roller made of a UV resin is made by using a raw UV-curing resin material for an elastic layer and a raw UV-curing resin material for a coating layer having a compounding recipe as shown in Table 4-1 in the same manner as in Example 4-1, and then the adhesion property between the elastic layer and the coating layer of the resulting roller is evaluated. These results are shown in Table 4-1. Moreover, anther roller made in the same manner as mentioned above is incorporated into an electro-photographic apparatus as a developing roller and left to stand under NN condition for 2 days and an endurance test is conducted for gray color, and as a result, the peeling of the coating layer is not observed even after 12000 sheets were printed and good images can be obtained. Furthermore, another roller made in the same manner as mentioned above is incorporated into an electro-photographic apparatus as a developing roller and left to stand under HH condition for 2 days and an image evaluation is conducted for gray color, and as a result, good images can be obtained.

### Comparative Example 4-1

A raw UV-curing resin material for an elastic layer having a compounding recipe shown in Table 4-1 is prepared, and then a cylindrical UV-cured resin sample for measuring properties is made in the same manner as in Example 4-1, and the Asker C hardness and compression residual strain are measured. Also, a sheet sample is made from the raw UV-curing resin material for the elastic layer in the same manner as in Example 4-1, and then the volume resistivity is measured. Then, a roller made of a UV resin is made by using a raw UV-curing resin material for an elastic layer and a raw UV-curing resin material for a coating layer having a compounding recipe as shown in Table 4-1 in the same manner as in Example 4-1, and then the adhesion property between the elastic layer and the coating layer of the resulting roller is evaluated. These results are shown in Table 4-1. Moreover, anther roller made in the same manner as mentioned above is incorporated into an electro-photographic apparatus as a developing roller and left to stand under NN condition for 2 days and an endurance test is conducted for gray color, and as a result, good image cannot be obtained when 6000 sheets were printed. The roller is brought out and observed, and as a result, the peeling of the coating layer is observed. Furthermore, another roller made in the same manner as mentioned above is incorporated into an electro-photographic apparatus as a developing roller and left to stand under HH condition for 2 days and an image evaluation is conducted for gray color, and as a result, good images can be obtained.

### Comparative Example 4-2

A raw UV-curing resin material for an elastic layer having a compounding recipe shown in Table 4-1 is prepared, and then a cylindrical UV-cured resin sample for measuring properties is made in the same manner as in Example 4-1, and the Asker C hardness and compression residual strain are measured. Also, a sheet sample is made from the raw UV-curing resin material for the elastic layer in the same manner as in Example 4-1, and then the volume resistivity is measured. Then, a roller made of a UV resin is made by using a raw UV-curing resin material for an elastic layer and a raw UV-curing resin material for a coating layer having a compounding recipe as shown in Table 4-1 in the same manner as in Example 4-1, and then the adhesion property between the elastic layer and the coating layer of the resulting roller is evaluated. These results are shown in Table 4-1. Moreover, anther roller made in the same manner as mentioned above is incorporated into an electro-photographic apparatus as a developing roller and left to stand under NN condition for 2 days and an endurance test is conducted for gray color, and as a result, the peeling of the coating layer is not observed even after 12000 sheets were printed and good images can be obtained. Furthermore, another roller made in the same manner as mentioned above is incorporated into an electro-photographic apparatus as a developing roller and left to stand under HH condition for 2 days and an image evaluation is conducted for gray color, and as a result, a stripe-shaped faulty image is caused. Also, traces due to pressure-contacting with a developing blade are observed on the surface of the developing roller.

### Comparative Example 4-3

A raw UV-curing resin material for an elastic layer having a compounding recipe shown in Table 4-1 is prepared, and then a cylindrical UV-cured resin sample for measuring properties is made in the same manner as in Example 4-1, and the Asker C hardness and compression residual strain are measured. Also, a sheet sample is made from the raw UV-curing resin material for the elastic layer in the same manner as in Example 4-1, and then the volume resistivity is measured. Then, a roller made of a UV resin is made by using a raw UV-curing resin material for an elastic layer and a raw UV-curing resin material for a coating layer having a compounding recipe as shown in Table 4-1 in the same manner as in Example 4-1, and then the adhesion property between the elastic layer and the coating layer of the resulting roller is evaluated. These results are shown in Table 4-1. Moreover, anther roller made in the same manner as mentioned above is incorporated into an electro-photographic apparatus as a developing roller and left to stand under NN condition for 2 days and an endurance test is conducted for gray color, and as a result, a good image cannot be obtained from an early stage and the peeling of the coating layer is caused when 1000 sheets were printed. Furthermore, another roller made in the same manner as mentioned above is incorporated into an electro-photographic apparatus as a developing roller and left to stand under HH condition for 2 days and an image evaluation is conducted for gray color, and as a result, a stripe-shaped faulty image is caused. Also, traces due to pressure-contacting with a developing blade are observed on the surface of the developing roller.

TABLE 4-1

| | | | Example 4-1 | Example 4-2 | Example 4-3 | Example 4-4 |
|---|---|---|---|---|---|---|
| Elastic layer | Urethane | Kind | UA- | UA- | UA- | UA- |
| | acrylate | | 334PZ | 334PZ | 334PZ | 334PZ |
| | oligomer | parts | 70 | 70 | 70 | 70 |
| | Acrylate | Kind | LIGHT- | LIGHT- | LIGHT- | LIGHT- |
| | monomer | | ACRYLATE | ACRYLATE | ACRYLATE | ACRYLATE |
| | | | MTG-A | MTG-A | IM-A | IM-A |
| | | parts | 20 | 20 | 20 | 20 |
| | | Functionality | 1 | 1 | 1 | 1 |
| | | Molecular | 218 | 218 | 268 | 268 |
| | | weight | | | | |
| | Partial ester | Kind | NK ESTER | NK ESTER | NK ESTER | NK ESTER |
| | | | A-SA | A-SA | A-SA | A-SA |
| | | parts | 10 | 10 | 10 | 10 |
| | Photo- | Kind | IRGACURE | IRGACURE | IRGACURE | IRGACURE |
| | polymerization | | 184D | 184D | 184D | 184D |
| | initiator | parts | 0.5 | 0.5 | 0.5 | 0.5 |
| | Conductive | Kind | MP-100 | MP-100 | MP-100 | MP-100 |
| | agent | parts | 2 | 2 | 2 | 2 |
| Coating layer | Oligomer | Kind | UV3000B | UV3000B | UX3301 | UV3200B |
| | | parts | 60 | 60 | 60 | 50 |
| | Acrylate | Kind | A-MO | A-MO | A-MO | A-MO |
| | monomer | parts | 40 | 40 | 40 | 40 |
| | | Functionality | 1 | 1 | 1 | 1 |
| | Acrylate | Kind | — | — | — | IB-XA |
| | monomer | parts | — | — | — | 10 |
| | | Functionality | — | — | — | 1 |
| | Photo- | Kind | IRGACURE | IRGACURE | IRGACURE | IRGACURE |
| | polymerization | | 184D | 184D | 184D | 184D |
| | initiator | parts | 1 | 1 | 1 | 1 |
| | Conductive | Kind | — | Ketjen black | — | — |
| | agent | | | EC600JD | | |
| | | parts | — | 1.5 | — | — |
| Asker C Hardness (degree) | | | 47 | 46 | 43 | 44 |
| Compression residual strain (%) | | | 3.6 | 3.5 | 3.0 | 3.2 |
| Volume resistivity (Ωcm) | | | 8.50E+06 | 4.50E+06 | 7.50E+06 | 8.70E+06 |
| Adhesion property | | | 25/25 | 25/25 | 25/25 | 25/25 |
| Endurance test of roller | | | good | good | good | good |
| H/H evaluation of image | | | good | good | good | good |
| | | | | Comparative | Comparative | Comparative |
| | | | Example 4-5 | Example 4-1 | Example 4-2 | Example 4-3 |
| Elastic layer | Urethane | Kind | UA- | UA- | UA- | UA- |
| | acrylate | | 334PZ | 334PZ | 334PZ | 334PZ |
| | oligomer | parts | 70 | 70 | 60 | 70 |
| | Acrylate | Kind | LIGHT- | LIGHT- | LIGHT- | LIGHT- |
| | monomer | | ACRYLATE | ACRYLATE | ACRYLATE | ACRYLATE |
| | | | IM-A | MTG-A | MTG-A | IM-A |
| | | parts | 10 | 30 | 10 | 30 |
| | | Functionality | 1 | 1 | 1 | 1 |
| | | Molecular | 268 | 218 | 218 | 268 |
| | | weight | | | | |
| | Partial ester | Kind | NK ESTER | — | NK ESTER | — |
| | | | A-SA | | A-SA | |
| | | parts | 20 | — | 30 | — |
| | Photo- | Kind | IRGACURE | IRGACURE | IRGACURE | IRGACURE |
| | polymerization | | 184D | 184D | 184D | 184D |
| | initiator | parts | 0.5 | 0.5 | 0.5 | 0.5 |
| | Conductive | Kind | MP-100 | MP-100 | MP-100 | — |
| | agent | parts | 2 | 2 | 2 | — |
| Coating layer | Oligomer | Kind | UV3000B | UV3000B | UX3301 | UV3000B |
| | | parts | 60 | 60 | 60 | 60 |
| | Acrylate | Kind | A-MO | A-MO | A-MO | A-MO |
| | monomer | parts | 40 | 40 | 40 | 40 |
| | | Functionality | 1 | 1 | 1 | 1 |
| | Acrylate | Kind | — | — | — | — |
| | monomer | parts | — | — | — | — |
| | | Functionality | — | — | — | — |
| | Photo- | Kind | IRGACURE | IRGACURE | IRGACURE | IRGACURE |
| | polymerization | | 184D | 184D | 184D | 184D |
| | initiator | parts | 1 | 1 | 1 | 1 |
| | Conductive | Kind | — | — | — | — |
| | agent | parts | — | — | — | — |

| | | | | |
|---|---|---|---|---|
| Asker C Hardness (degree) | 47 | 45 | 49 | 38 |
| Compression residual strain (%) | 3.6 | 2.8 | 8.7 | 2.7 |
| Volume resistivity (Ωcm) | 8.00E+06 | 7.60E+06 | 8.50E+06 | 3.70E+11 |
| Adhesion property | 25/25 | 2/25 | 25/25 | 1/25 |
| Endurance test of roller | good | bad | good | bad |
| H/H evaluation of image | good | good | bad | bad |

UA-334PZ: manufactured by Shin-Nakamura Chemical Co., Ltd.
LIGHT-ACRYLATE MTG-A: methoxy triethylene glycol acrylate, functionality = 1, molecular weight = 218, manufactured by Kyoei-Sha Chemical Co., Ltd.
LIGHT-ACRYLATE IM-A: isomyristyl acrylate, functionality = 1, molecular weight = 268, manufactured by Kyoei-Sha Chemical Co., Ltd.
NK ESTER A-SA: β-acryloyloxyethyl hydrogen succinate, manufactured by Shin-Nakamura Chemical Co., Ltd.
IRGACURE 184D: manufactured by Ciba Specialty Chemicals Co., Ltd.
MP-100: manufactured by Akishima Chemical Industry Co., Ltd.
UV3000B: manufactured by Nippon Synthetic Chemical Industry Co., Ltd.
UX3301: manufactured by Nippon Kayaku Co., Ltd.
UV3200B: manufactured by Nippon Synthetic Chemical Industry Co., Ltd.
A-MO: morpholine acrylate, manufactured by Shin-Nakamura Chemical Co., Ltd., functionality = 1
IB-XA: manufactured by Kyoei-Sha Chemical Co., Ltd., functionality = 1
Ketjen black EC600JD: manufactured by Ketjen Black International Co., Ltd., distributed from Lion Corporation

As seen from Examples 4-1 to 4-5, the conductive elastic roller provided with the elastic layer composed of an ultraviolet-cured type resin formed by curing a raw material mixture comprising an urethane acrylate oligomer (A), a photo-polymerization initiator (B), a conductive agent (C) and a partial ester (E) through ultraviolet irradiation and the coating layer composed of an ultraviolet-curing type resin formed by curing a raw material mixture comprising an urethane acrylate oligomer (A) and a photo-polymerization initiator (B) through ultraviolet irradiation is high in the adhesion property between the elastic layer and the coating layer.

On the other hand, as seen from Comparative Examples 4-1 and 4-3, the conductive elastic roller provided with the elastic layer composed of an ultraviolet-curing type resin formed by curing a raw material mixture not comprising the partial ester (E) through ultraviolet irradiation is low in the adhesion property between the elastic layer and the coating layer. Moreover, as seen from Comparative Example 4-2, when the amount of the partial ester (E) becomes large, the compression residual strain is unfavorably increased. Furthermore, as seen from Comparative Example 4-3, the conductive elastic roller provided with the elastic layer composed of an ultraviolet-curing type resin formed by curing a raw material mixture not comprising the conductive agent (C) through ultraviolet irradiation is very low in the electric conductivity.

<Fifth Conductive Elastic Roller>

### Example 5-1

100 parts by mass of a bifunctional high purity polyol having a molecular weight of 4,000 [PREMINOL S-X4004, manufacture by Asahi Glass Co., Ltd., a polyol composed of a PO chain, hydroxyl value=27.9 mgKOH/g, total unsaturation degree=0.007 meq/g, right part (0.6/x+0.01) of the formula (I)=0.03], 8.29 parts by mass of isophorone diisocyanate [isocyanate group/hydroxyl group of the polyol=3/2=1.50 (molar ratio)] and 0.01 part by mass of dibutyltin dilaurate are reacted at 70° C. for 2 hours while warming with stirring to synthesize an urethane prepolymer having isocyanate groups at both ends of its molecular chain. Furthermore, 100 parts by mass of the urethane prepolymer is mixed and reacted with 2.88 parts by mass of 2-hydroxyethyl acrylate (HEA) at 70° C. for 2 hours with stirring to synthesize an urethane acrylate oligomer (A2-1) having a molecular weight of 9,000. The resulting urethane acrylate oligomer (A2-1) has a viscosity at 25° C. of 80,000 mPa·s as measured by a B-type viscometer.

70.0 parts by mass of the urethane acrylate oligomer (A2-1), 30.0 parts by mass of an acrylate monomer manufactured by Kyoei-Sha Chemical Co., Ltd., “LIGHT-ACRYLATE IM-A (isomyristyl acrylate)”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material. The resulting raw UV-curing resin material has a viscosity of 10,000 mPa·s.

The raw UV-curing resin material is poured into a mold having a cavity of 12.7 mm in depth and 29 mm in inner diameter, capped with a quartz glass plate and then irradiated with UV at an irradiation intensity of 700 mW/cm² for 10 seconds to obtain a cylindrical UV-cured resin sample for measuring properties. This sample has an Asker C hardness at a plane part of 56 degrees [measured by an apparatus manufactured by KOBUNSHI KEIKI Co., Ltd.]. Moreover, this sample has a compression residual strain of 1.8% as measured according to JIS K 6262 (1997).

Then, the raw UV-curing resin material is applied onto a conductive roller base material made of polybutylene terephthalate (PBT) resin having an outer diameter of 17.0 mm and inserted with a metal shaft having an outer diameter of 6.0 mm at a thickness of 1500 μm through a die coater, during which the raw UV-curing resin material is cured through spot UV-irradiation. The roller with the thus formed elastic layer made of the UV-cured resin is further irradiated with UV at an irradiation intensity of 700 mW/cm for 5 seconds while rotating under nitrogen atmosphere.

A raw UV-curing resin material containing microparticles with a hardness higher than that of the elastic layer is applied onto the surface of the thus obtained roller with the elastic layer made of the UV-cured resin through a roll coater and irradiated with UV to obtain a low-hardness UV-cured resin roller having a UV coating on its surface and a roller outer diameter of 20.0 mm. This roller is incorporated into an electro-photographic apparatus as a developing roller to print pure white, pure black and grayscale images, and as a result, good images can be obtained.

Then, for a staining test of a photosensitive drum, a cartridge incorporated with the roller is left to stand in a light-tight convection oven at 50° C. for 5 days and taken out therefrom and left to stand under an environment of 20° C. and 50% RH for 1 hour, and then 50 sheets of gray images are printed, and as a result, good images can be obtained and a faulty image due to the staining of the photosensitive drum and the deformation of the roller is not observed.

### Example 5-2

100 parts by mass of a bifunctional high purity polyol having a molecular weight of 2,000 [PREMINOL S—X4001, manufacture by Asahi Glass Co., Ltd., a polyol composed of a PO chain, hydroxyl value=55.3 mgKOH/g, total unsaturation degree=0.008 meq/g, right part (0.6/x+0.01) of the formula (I)=0.02], 13.70 parts by mass of isophorone diisocyanate [isocyanate group/hydroxyl group of the polyol=5/4=1.25 (molar ratio)] and 0.01 part by mass of dibutyltin dilaurate are reacted at 70° C. for 2 hours while warming with stirring to synthesize an urethane prepolymer having isocyanate groups at both ends of its molecular chain. Furthermore, 100 parts by mass of the urethane prepolymer is mixed and reacted with 2.86 parts by mass of 2-hydroxyethyl acrylate (HEA) at 70° C. for 2 hours with stirring to synthesize an urethane acrylate oligomer (A2-2) having a molecular weight of 9,000. The resulting urethane acrylate oligomer (A2-2) has a viscosity at 25° C. of 170,000 mPa·s as measured by a B-type viscometer.

70.0 parts by mass of the urethane acrylate oligomer (A2-2), 30.0 parts by mass of an acrylate monomer manufactured by Kyoei-Sha Chemical Co., Ltd., “LIGHT-ACRYLATE IM-A (isomyristyl acrylate)”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material. The resulting raw UV-curing resin material has a viscosity of 15,000 mPa·s.

A cylindrical UV-cured resin sample for measuring properties is made by using the raw UV-curing resin material in the same manner as in Example 5-1, and then the Asker C hardness and compression residual strain are measured. These results are shown in Table 5-2. Moreover, a roller made of the UV-cured resin is made by using the raw UV-curing resin material in the same manner as in Example 5-1, and then the resulting roller is incorporated into an electro-photographic apparatus as a developing roller to print pure white, pure black and grayscale images, and as a result, good images can be obtained. Then, a cartridge incorporated with the roller is left to stand in a light-tight convection oven at 50° C. for 5 days and taken out therefrom and left to stand under an environment of 20° C. and 50% RH for 1 hour, and then 50 sheets of gray images are printed, and as a result, good images can be obtained and a faulty image due to the staining of the photosensitive drum and the deformation of the roller is not observed.

### Example 5-3

100 parts by mass of a bifunctional high purity polyol having a molecular weight of 3,200 [Acclaim 3205, manufacture by Sumika Bayer Urethane Co., Ltd., a polyol mainly containing a PO chain and slightly containing an EO chain, hydroxyl value=35.0 mgKOH/g, total unsaturation degree=0.002 meq/g, right part (0.6/x+0.01) of the formula (I)=0.03], 10.41 parts by mass of isophorone diisocyanate [isocyanate group/hydroxyl group of the polyol=3/2=1.50 (molar ratio)] and 0.01 part by mass of dibutyltin dilaurate are reacted at 70° C. for 2 hours while warming with stirring to synthesize an urethane prepolymer having isocyanate groups at both ends of its molecular chain. Furthermore, 100 parts by mass of the urethane prepolymer is mixed and reacted with 3.63 parts by mass of 2-hydroxyethyl acrylate (HEA) at 70° C. for 2 hours with stirring to synthesize an urethane acrylate oligomer (A2-3) having a molecular weight of 7,000. The resulting urethane acrylate oligomer (A2-3) has a viscosity at 25° C. of 70,000 mPa·s as measured by a B-type viscometer.

70.0 parts by mass of the urethane acrylate oligomer (A2-3), 30.0 parts by mass of an acrylate monomer manufactured by Kyoei-Sha Chemical Co., Ltd., “LIGHT-ACRYLATE IM-A (isomyristyl acrylate)”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material. The resulting raw UV-curing resin material has a viscosity of 10,000 mPa·s.

A cylindrical UV-cured resin sample for measuring properties is made by using the raw UV-curing resin material in the same manner as in Example 5-1, and then the Asker C hardness and compression residual strain are measured. These results are shown in Table 5-2. Moreover, a roller made of the UV-cured resin is made by using the raw UV-curing resin material in the same manner as in Example 5-1, and then the resulting roller is incorporated into an electro-photographic apparatus as a developing roller to print pure white, pure black and grayscale images, and as a result, good images can be obtained. Then, a cartridge incorporated with the roller is left to stand in a light-tight convection oven at 50° C. for 5 days and taken out therefrom and left to stand under an environment of 20° C. and 50% RH for 1 hour, and then 50 sheets of gray images are printed, and as a result, good images can be obtained and a faulty image due to the staining of the photosensitive drum and the deformation of the roller is not observed.

### Example 5-4

100 parts by mass of a bifunctional high purity polyol having a molecular weight of 5,500 [PREMINOL S-4006, manufacture by Asahi Glass Co., Ltd., a polyol composed of a PO chain, hydroxyl value=21.1 mgKOH/g, total unsaturation degree=0.006 meq/g, right part (0.6/x+0.01) of the formula (I)=0.04], 6.69 parts by mass of isophorone diisocyanate [isocyanate group/hydroxyl group of the polyol=8/5=1.60 (molar ratio)] and 0.01 part by mass of dibutyltin dilaurate are reacted at 70° C. for 2 hours while warming with stirring to synthesize an urethane prepolymer having isocyanate groups at both ends of its molecular chain. Furthermore, 100 parts by mass of the urethane prepolymer is mixed and reacted with 2.62 parts by mass of 2-hydroxyethyl acrylate (HEA) at 70° C. for 2 hours with stirring to synthesize an urethane acrylate oligomer (A2-4) having a molecular weight of 11,000. The resulting urethane acrylate oligomer (A2-4) has a viscosity at 25° C. of 60,000 mPa·s as measured by a B-type viscometer.

70.0 parts by mass of the urethane acrylate oligomer (A2-4), 30.0 parts by mass of an acrylate monomer manufactured by Kyoei-Sha Chemical Co., Ltd., “LIGHT-ACRYLATE IM-A (isomyristyl acrylate)”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material. The resulting raw UV-curing resin material has a viscosity of 9,000 mPa·s.

A cylindrical UV-cured resin sample for measuring properties is made by using the raw UV-curing resin material in the same manner as in Example 5-1, and then the Asker C hardness and compression residual strain are measured. These results are shown in Table 5-2. Moreover, a roller made of the UV-cured resin is made by using the raw UV-curing resin material in the same manner as in Example 5-1, and then the resulting roller is incorporated into an electro-photographic apparatus as a developing roller to print pure white, pure black and grayscale images, and as a result, good images can be obtained. Then, a cartridge incorporated with the roller is left in a light-tight convection oven at 50° C. for 5 days and taken out therefrom and left to stand under an environment of 20° C. and 50% RH for 1 hour, and then 50 sheets of gray images are printed, and as a result, good images can be obtained and a faulty image due to the staining of the photosensitive drum and the deformation of the roller is not observed.

### Comparative Example 5-1

100 parts by mass of a bifunctional polyol having a molecular weight of 3,200 [EXCENOL 3020, manufacture by Asahi Glass Co., Ltd., a polyol composed of a PO chain, hydroxyl value=37.4 mgKOH/g, total unsaturation degree=0.084 meq/g, right part (0.6/x+0.01) of the formula (I)=0.03], 10.40 parts by mass of isophorone diisocyanate [isocyanate group/hydroxyl group of the polyol=3/2=1.50 (molar ratio)] and 0.01 part by mass of dibutyltin dilaurate are reacted at 70° C. for 2 hours while warming with stirring to synthesize an urethane prepolymer having isocyanate groups at both ends of its molecular chain. Furthermore, 100 parts by mass of the urethane prepolymer is mixed and reacted with 3.30 parts by mass of 2-hydroxyethyl acrylate (HEA) at 70° C. for 2 hours with stirring to synthesize an urethane acrylate oligomer (A-5) having a molecular weight of 7,000. The resulting urethane acrylate oligomer (A-5) has a viscosity at 25° C. of 30,000 mPa·s as measured by a B-type viscometer.

70.0 parts by mass of the urethane acrylate oligomer (A-5), 30.0 parts by mass of an acrylate monomer manufactured by Kyoei-Sha Chemical Co., Ltd., “LIGHT-ACRYLATE IM-A (isomyristyl acrylate)”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material. The resulting raw UV-curing resin material has a viscosity of 5,000 mPa·s.

A cylindrical UV-cured resin sample for measuring properties is made by using the raw UV-curing resin material in the same manner as in Example 5-1, and then the Asker C hardness and compression residual strain are measured. These results are shown in Table 5-2. Moreover, a roller made of the UV-cured resin is made by using the raw UV-curing resin material in the same manner as in Example 5-1, and then the resulting roller is incorporated into an electro-photographic apparatus as a developing roller to print pure white, pure black and grayscale images, and as a result, good images can be obtained. Then, a cartridge incorporated with the roller is left in a light-tight convection oven at 50° C. for 5 days and taken out therefrom and left to stand under an environment of 20° C. and 50% RH for 1 hour, and then 50 sheets of gray images are printed, and as a result, white stripes equally spaced appear in the image and it is confirmed from a distance of an interval that the faulty image is caused by the staining of the photosensitive drum and traces due to pressure-contacting with a blade.

### Comparative Example 5-2

100 parts by mass of a bifunctional polyol having a molecular weight of 3,200 [EXCENOL 3020, manufacture by Asahi Glass Co., Ltd., a polyol composed of a PO chain, hydroxyl value=37.4 mgKOH/g, total unsaturation degree=0.084 meq/g, right part (0.6/x+0.01) of the formula (I)=0.03], 9.20 parts by mass of isophorone diisocyanate [isocyanate group/hydroxyl group of the polyol=4/3=1.33 (molar ratio)] and 0.01 part by mass of dibutyltin dilaurate are reacted at 70° C. for 2 hours while warming with stirring to synthesize an urethane prepolymer having isocyanate groups at both ends of its molecular chain. Furthermore, 100 parts by mass of the urethane prepolymer is mixed and reacted with 2.20 parts by mass of 2-hydroxyethyl acrylate (HEA) at 70° C. for 2 hours with stirring to synthesize an urethane acrylate oligomer (A-6) having a molecular weight of 11,000. The resulting urethane acrylate oligomer (A-6) has a viscosity at 25° C. of 60,000 mPa·s as measured by a B-type viscometer.

70.0 parts by mass of the urethane acrylate oligomer (A-6), 30.0 parts by mass of an acrylate monomer manufactured by Kyoei-Sha Chemical Co., Ltd., “LIGHT-ACRYLATE IM-A (isomyristyl acrylate)”, 0.5 part by mass of a photo-polymerization initiator manufactured by Ciba Specialty Chemicals Co., Ltd., “IRGACURE 184D” and 2.0 parts by mass of an ion conductive agent manufactured by Akishima Chemical Industry Co., Ltd., “MP-100” are stirred and mixed by an agitator at a liquid temperature of 70° C. and 60 revolutions/minute for 1 hour, and the resulting mixture is filtered to obtain a raw UV-curing resin material. The resulting raw UV-curing resin material has a viscosity of 8,000 mPa·s.

A cylindrical UV-cured resin sample for measuring properties is made by using the raw UV-curing resin material in the same manner as in Example 5-1, and then the Asker C hardness and compression residual strain are measured. These results are shown in Table 5-2. Moreover, a roller made of the UV-cured resin is made by using the raw UV-curing resin material in the same manner as in Example 5-1, and then the resulting roller is incorporated into an electro-photographic apparatus as a developing roller to print pure white, pure black and grayscale images, and as a result, good images can be obtained. Then, a cartridge incorporated with the roller is left in a light-tight convection oven at 50° C. for 5 days and taken out therefrom and left to stand under an environment of 20° C. and 50% RH for 1 hour, and then 50 sheets of gray images are printed, and as a result, white stripes equally spaced appear in the image and it is confirmed from a distance of an interval that the faulty image is caused by the staining of the photosensitive drum and traces due to pressure-contacting with a blade.

TABLE 5-1
Recipes of raw materials in the synthesis of urethane acrylate oligomers and properties of the products

| | | Example | Example | Example | Example | Comparative | Comparative |
|---|---|---|---|---|---|---|---|
| | | 5-1 | 5-2 | 5-3 | 5-4 | Example 5-1 | Example 5-2 |
| Kind of urethane acrylate | | (A2-1) | (A2-2) | (A2-3) | (A2-4) | (A-5) | (A-6) |
| oligomer | | | | | | | |
| PREMINOL S-X4004 | parts | 100.00 | — | — | — | — | — |
| PREMINOL S-X4001 | by | — | 100.00 | — | — | — | — |
| Acclaim 3205 | mass | — | — | 100.00 | — | — | — |
| PREMINOL S-4006 | | — | — | — | 100.00 | — | — |
| EXCENOL 3020 | | — | — | — | — | 100.00 | 100.00 |
| Isophorone diisocanate | | 8.29 | 13.70 | 10.41 | 6.69 | 10.40 | 9.20 |
| Dibutyltin dilaurate | | 0.01 | 0.01 | 0.01 | 0.01 | 0.01 | 0.01 |
| 2-hydroxyethyl acrylate | | 2.88 | 2.86 | 3.63 | 2.62 | 3.30 | 2.20 |

| | | | | | | |
|---|---|---|---|---|---|---|
| Molar ratio of | 3/2 | 5/4 | 3/2 | 8/5 | 3/2 | 4/3 |
| isocyanate group/hydroxyl group | 1.50 | 1.25 | 1.50 | 1.60 | 1.50 | 1.33 |
| Molecular weight of the | 9000 | 9000 | 7000 | 11000 | 7000 | 11000 |
| oligomer produced | | | | | | |
| Functionality of the oligomer | 2 | 2 | 2 | 2 | 2 | 2 |
| produced | | | | | | |
| Viscosity at 25° C. of the | 80000 | 170000 | 70000 | 60000 | 30000 | 60000 |
| oligomer produced (mPa · s) | | | | | | |

TABLE 5-2
Recipes of raw UV-curing resin materials and properties as well as evaluation results of the image

| | | | Example | Example | Example | Example | Comparative | Comparative |
|---|---|---|---|---|---|---|---|---|
| | | | 5-1 | 5-2 | 5-3 | 5-4 | Example 5-1 | Example 5-2 |
| Oligomer | Urethane acrylate oligomer | parts | 70.0 | — | — | — | — | — |
| | (A2-1) | by | | | | | | |
| | Urethane acrylate oligomer | mass | — | 70.0 | — | — | — | — |
| | (A2-2) | | | | | | | |
| | Urethane acrylate oligomer | | — | — | 70.0 | — | — | — |
| | (A2-3) | | | | | | | |
| | Urethane acrylate oligomer | | — | — | — | 70.0 | — | — |
| | (A2-4) | | | | | | | |
| | Urethane acrylate oligomer | | — | — | — | — | 70.0 | — |
| | (A-5) | | | | | | | |
| | Urethane acrylate oligomer | | — | — | — | — | — | 70.0 |
| | (A-6) | | | | | | | |
| Monomer | LIGHT-ACRYLATE IM-A | | 30.0 | 30.0 | 30.0 | 30.0 | 30.0 | 30.0 |
| Initiator | IRGACURE 184D | | 0.5 | 0.5 | 0.5 | 0.5 | 0.5 | 0.5 |
| Conductive | MP-100 | | 2.0 | 2.0 | 2.0 | 2.0 | 2.0 | 2.0 |
| agent | | | | | | | | |

| | | | | | | |
|---|---|---|---|---|---|---|
| Viscosity of the raw UV-curing resin material | 10000 | 15000 | 10000 | 9000 | 5000 | 8000 |
| (mPa · s) | | | | | | |
| Asker C Hardness (degree) | 56 | 54 | 60 | 55 | 54 | 48 |
| Compression residual strain (%) | 1.8 | 1.6 | 1.2 | 1.7 | 3.5 | 4.8 |
| Staning test of the photosensitive drum | good | good | good | good | bad | bad |

LIGHT-ACRYLATE IM-A: an acrylate monomer, isomyristyl acrylate, manufactured by Kyoei-Sha Chemical Co., Ltd.
IRGACURE 184D: a photo-polymerization initiator, manufactured by Ciba Specialty Chemicals Co., Ltd.
MP-100: an ion conductive agent, manufactured by Akishima Chemical Industry Co., Ltd.

As seen from Examples 5-1 to 5-4, in the conductive elastic roller provided with the elastic layer composed of an ultraviolet-curing type resin formed by curing a raw material for the elastic layer comprising an urethane acrylate oligomer (A2) synthesized by using a high purity polyol satisfying a relation of the equation (II), a photo-polymerization initiator (B) and a conductive agent (C) through ultraviolet irradiation, the elastic layer is low in the hardness and small in the compression residual strain and does not contaminate the photosensitive drum.

On the other hand, as seen from Comparative Examples 5-1 and 5-2, when the elastic layer is formed by using an urethane acrylate oligomer synthesized by using only a polyol not satisfying a relation of the equation (II) as a polyol, the conductive elastic roller contaminates the photosensitive drum and traces due to pressure-contacting with a blade remain thereon, so that a faulty image is caused.

1. A conductive elastic roller comprising a shaft member and one or more elastic layers disposed on an outside of the shaft member in a radial direction, characterized in that at least one of the elastic layers is composed of an ultraviolet-curing type resin formed by curing a raw material for the elastic layer comprising an urethane acrylate oligomer (A), a photo-polymerization initiator (B) and a conductive agent (C) through ultraviolet irradiation, and the urethane acrylate oligomer (A) is an urethane acrylate oligomer (A1) having a functionality of 1.0-3.0 and a molecular weight of 5,000-100,000.

2. A conductive elastic roller according to claim 1, wherein the urethane acrylate oligomer (A1) has a polymer chain derived from a polyol having a molecular weight of 500-15,000.

3. A conductive elastic roller comprising a shaft member and one or more elastic layers disposed on an outside of the shaft member in a radial direction, characterized in that at least one of the elastic layers is composed of an ultraviolet-curing type resin formed by curing a raw material for the elastic layer comprising an urethane acrylate oligomer (A), a photo-polymerization initiator (B) and a conductive agent (C) through ultraviolet irradiation, and the conductive agent (C) is a lithium salt (C1).

4. A conductive elastic roller according to claim 3, wherein a content of the lithium salt (C1) in the raw material for the elastic layer is 0.1-5.0% by mass.

5. A conductive elastic roller comprising a shaft member and one or more elastic layers disposed on an outside of the shaft member in a radial direction, characterized in that at least one of the elastic layers is composed of an ultraviolet-curing type resin formed by curing a raw material for the elastic layer comprising an urethane acrylate oligomer (A), a photo-polymerization initiator (B), a conductive agent (C) and an acrylate monomer (D) through ultraviolet irradiation, and at least a part of the acrylate monomer (D) is an acrylate monomer (D1) represented by the following general formula (I): 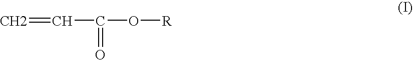
[wherein R is an alkyl group, a cycloalkyl group, an aryl group or an aralkyl group].

6. A conductive elastic roller according to claim 5, wherein R in the general formula (I) has a carbon number of 12-18.

7. A conductive elastic roller according to claim 5, wherein at least a part of the acrylate monomer (D) is at least one selected from the group consisting of isomyristyl acrylate, lauryl acrylate and stearyl acrylate.

8. A conductive elastic roller comprising a shaft member, one or more elastic layers disposed on an outside of the shaft member in a radial direction and one or more coating layers disposed on an outside of the elastic layer in a radial direction, characterized in that at least an outermost layer of the elastic layers is composed of an ultraviolet-curing type resin formed by curing a raw material mixture comprising an urethane acrylate oligomer (A), a photo-polymerization initiator (B) and a conductive agent (C) through ultraviolet irradiation, and the raw material mixture for the outermost layer of the elastic layers further contains a partial ester (E) of a (metha)acrylate having a hydroxyl group and a polyvalent carboxylic acid.

9. A conductive elastic roller according to claim 8, wherein the partial ester (E) of the (metha)acrylate having the hydroxyl group and the polyvalent carboxylic acid is a monoester of an acrylate having a hydroxyl group and a bivalent carboxylic acid.

10. A conductive elastic roller according to claim 8, wherein the partial ester (E) of the (metha)acrylate having the hydroxyl group and the polyvalent carboxylic acid is a monoester of at least one selected from the group consisting of 2-hydroxyethyl acrylate, 2-hydroxyethyl methacrylate, 2-hydroxypropyl acrylate, 2-hydroxypropyl methacrylate and pentaerythritol triacrylate and at least one selected from the group consisting of succinic acid, phthalic acid, tetrahydrophthalic acid, methyl tetrahydrophthalic acid, hexahydrophthalic acid, methyl hexahydrophthalic acid, hymic acid and methyl hymic acid.

11. A conductive elastic roller according to claim 8, wherein a content of the partial ester (E) in the raw material mixture for the outermost layer of the elastic layers is 1-20% by mass.

12. A conductive elastic roller comprising a shaft member and one or more elastic layers disposed on an outside of the shaft member in a radial direction, characterized in that at least one of the elastic layers is composed of an ultraviolet-curing type resin formed by curing a raw material for the elastic layer comprising an urethane acrylate oligomer (A), a photo-polymerization initiator (B) and a conductive agent (C) through ultraviolet irradiation, and the urethane acrylate oligomer (A) is an urethane acrylate oligomer (A2) synthesized by using as a polyol a high purity polyol satisfying the following equation (II):
y≦0.6/x+0.01 (II)
[wherein x is a hydroxyl value (mg KOH/g) of the polyol and y is a total unsaturation degree (meq/g) of the polyol] alone, or the high purity polyol and another polyol.

13. A conductive elastic roller according to claim 12, wherein the high purity polyol used for the synthesis of the urethane acrylate oligomer (A2) has a molecular weight of 1,000-16,000.

14. A conductive elastic roller according to claim 12, wherein a mass ratio (a1/a2) of the high purity polyol (a1) to the other polyol (a2) in the polyol used for the synthesis of the urethane acrylate oligomer (A2) is within a range of 100/0-30/70.

15. A conductive elastic roller according to claim 1, wherein the raw material for the elastic layer further contains an acrylate monomer (D).

16. A conductive elastic roller according to claim 15, wherein the acrylate monomer (D) has a functionality of 1.0-10 and a molecular weight of 100-2,000.

17. A conductive elastic roller according to claim 1, wherein the conductive agent (C) is an ion conductive agent (C2).

18. A conductive elastic roller according to claim 1, wherein the raw material for the elastic layer used in the ultraviolet-curing type resin has a mass ratio (A/D) of the urethane acrylate oligomer (A) to the acrylate monomer (D) of 100/0-10/90, and comprises 0.2-5.0 parts by mass of the photo-polymerization initiator (B) and 0.1-5.0 parts by mass of the conductive agent (C) based on 100 parts by mass of the total amount of the urethane acrylate oligomer (A) and the acrylate monomer (D).

19. An image forming apparatus using a conductive elastic roller as claimed in claim 1.
